(19) United States
(12) Patent Application Publication
(10) Pub. No.: US 2025/0376350 A1
(43) Pub. Date: Dec. 11, 2025

(54) MEDIUM PROCESSING APPARATUS AND IMAGE FORMING SYSTEM

(71) Applicants: Takashi YAMAMOTO, Kanagawa (JP); Kei SASAKI, Kanagawa (JP); Nobuyoshi SUZUKI, Kanagawa (JP); Mitsuhiro SUGAWARA, Kanagawa (JP); Keisuke SUGIYAMA, Kanagawa (JP); Kazuki SETO, Kanagawa (JP); Sachika TAMAKI, Kanagawa (JP); Kohta ABE, Kanagawa (JP); Shohei SAITO, Kanagawa (JP)

(72) Inventors: Takashi YAMAMOTO, Kanagawa (JP); Kei SASAKI, Kanagawa (JP); Nobuyoshi SUZUKI, Kanagawa (JP); Mitsuhiro SUGAWARA, Kanagawa (JP); Keisuke SUGIYAMA, Kanagawa (JP); Kazuki SETO, Kanagawa (JP); Sachika TAMAKI, Kanagawa (JP); Kohta ABE, Kanagawa (JP); Shohei SAITO, Kanagawa (JP)

(73) Assignee: Ricoh Company, Ltd., Tokyo (JP)

(21) Appl. No.: 19/221,014

(22) Filed: May 28, 2025

(30) Foreign Application Priority Data
Jun. 5, 2024 (JP) 2024-091750

(51) Int. Cl. B65H 37/04; B41J 11/00; G03G 15/00

(52) U.S. Cl. CPC B65H 37/04; B41J 11/0015; B65H 2301/51616; B65H 2301/5162; B65H 2801/27; G03G 15/6544

(57) ABSTRACT

A medium processing apparatus includes a liquid applier to perform liquid application to a medium, a medium processing device to perform processing on a medium bundle including the medium on which the liquid application has been performed by the liquid applier, a liquid storage to store the liquid used for the liquid application, a liquid application mover to enable the liquid applier to reciprocate along a direction orthogonal to a conveyance direction of the medium to the liquid applier, and a liquid supplier including a liquid supply unit to supply the liquid from the liquid storage to the liquid applier. The liquid supply unit includes a spiral portion to expand and contract to follow movement of the liquid applier and a linear portion to engage with the spiral portion with another member. The linear portion is covered with a non-stretchable protector.

### CROSS-REFERENCE TO RELATED APPLICATION

This patent application is based on and claims priority pursuant to 35 U.S.C. § 119 (a) to Japanese Patent Application No. 2024-091750, filed on Jun. 5, 2024, in the Japan Patent Office, the entire disclosure of which is hereby incorporated by reference herein.

### BACKGROUND

### Technical Field

The present disclosure relates to a medium processing apparatus and an image forming system.

### Related Art

Various types of medium processing apparatuses have been proposed that bind a sheet bundle of stacked sheet media. Such medium processing apparatuses employ binding processes including, for example, a “stapling process” for penetrating needle-shaped members (binding members) through a sheet bundle to bind the sheet bundle and a “crimping process” for performing pressure deformation on a portion of a sheet bundle to bind the sheet bundle. In the crimping process, in order to enhance the binding strength, some medium processing apparatuses have a function to apply liquid to a part of a sheet bundle to be pressed and deformed.

In order to apply liquid to sheets as sheet-shaped media when performing crimping, a liquid reserve tank and an expansion tank may be disposed in a binding unit that moves back and forth (reciprocates), and a user can remove the expansion tank from the binding unit and supply liquid.

### SUMMARY

The present disclosure described herein provides a medium processing apparatus that includes a liquid applier, a medium processing device, a liquid storage, a liquid application mover, and a liquid supplier. The liquid applier performs liquid application to a medium. The medium processing device performs processing on a medium bundle including the medium on which the liquid application has been performed by the liquid applier. The liquid storage stores the liquid used for the liquid application. The liquid application mover enables the liquid applier to reciprocate along a direction orthogonal to a conveyance direction of the medium to the liquid applier. The liquid supplier includes a liquid supply unit to supply the liquid from the liquid storage to the liquid applier. The liquid supply unit includes a spiral portion to expand and contract to follow movement of the liquid applier and a linear portion to engage with the spiral portion with another member. The linear portion is covered with a non-stretchable protector.

The present disclosure described herein also provides an image forming system that includes an image forming apparatus and the medium processing apparatus. The image forming apparatus forms an image on media. The medium processing apparatus performs the predetermined processing on the medium bundle including the media on which the image is formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment;

FIG. 3 is a schematic view of an edge binder viewed from an upstream side in a conveyance direction;

FIG. 4 is a schematic view of an edge binder viewed from the side on which a liquid applier is located in a main scanning direction;

FIGS. 5A and 5B are schematic diagrams illustrating a configuration of a crimper of an edge binder;

FIG. 6 is a diagram illustrating an edge binder according to a modification;

FIGS. 7A, 7B, and 7C are diagrams illustrating a liquid application crimper of an edge binder according to a modification;

FIGS. 8A, 8B, and 8C are diagrams illustrating a liquid applying operation and a crimping operation performed by the liquid application crimper of FIGS. 7A, 7B, and 7C;

FIG. 9 is a schematic view of a staple binder viewed from an upstream side in a conveyance direction;

FIG. 10 is a schematic view of a staple binder according to a modification, viewed from an upstream side in a conveyance direction;

FIG. 11 is a diagram illustrating a hardware configuration of control blocks that control the post-processing apparatus according to the first embodiment;

FIGS. 12A and 12B are diagrams illustrating a location and configuration of a second liquid storage tank in a post-processing apparatus;

FIG. 13 is a diagram illustrating a configuration of attachment and detachment of a second liquid storage tank in a post-processing apparatus;

FIG. 14 is a flowchart of a binding process performed by an edge binder;

FIGS. 15A to 15D are diagrams illustrating positions of a liquid applier and a crimper during a binding process by an edge binder;

FIGS. 16A to 16H are diagrams illustrating positions of a liquid applier and a crimper during a binding process by an edge binder;

FIG. 17 is a diagram of an edge binder and components around the edge binder, viewed from an upstream side in a conveyance direction;

FIG. 18 is a diagram of an edge binder and components around the edge binder, viewed from an upstream side in a conveyance direction;

FIGS. 19A to 19D are schematic views of a supply coupler used in an edge binder;

FIG. 20 is a sectional view of the supply coupler of FIGS. 19A to 19D attached to the edge binder;

FIG. 21 is a perspective view of a protector used in an edge binder;

FIG. 22 is a sectional view of an edge binder in which a spiral member included in the edge binder is contracted;

FIG. 23 is a perspective view of a protector used in an edge binder;

FIG. 24 is a diagram illustrating a mounting structure of a second supply protector;

FIG. 25 is a diagram illustrating an example of fixing of a second supply protector;

FIG. 26 is a diagram illustrating an internal structure of a post-processing apparatus according to a second embodiment;

FIGS. 27A, 27B, and 27C are schematic views of an internal tray according to the second embodiment, viewed from a thickness direction of a sheet;

FIG. 28 is a schematic view of a crimper according to the second embodiment, viewed from a downstream side in a conveyance direction;

FIGS. 29A and 29B are schematic views of a liquid applier according to the second embodiment, viewed from a thickness direction of a sheet;

FIGS. 30A, 30B, and 30C are sectional views of the liquid applier, taken along a line XXV-XXV of FIG. 29A;

FIGS. 31A, 31B, and 31C are sectional views of the liquid applier taken along a line XXVI-XXVI of FIG. 29A.

FIG. 32 is a diagram illustrating a hardware configuration of control blocks of the post-processing apparatus according to the second embodiment;

FIG. 33 is a flowchart of post-processing of the post-processing apparatus according to the second embodiment;

FIG. 34 is a diagram illustrating an overall configuration of an image forming system according to a modification;

FIGS. 35A and 35B are schematic views of a post-processing apparatus including controllers according to a first modification; and

FIGS. 36A and 36B are schematic views of a post-processing apparatus including controllers according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. Note that identical parts are given identical reference signs and redundant descriptions are summarized or omitted accordingly.

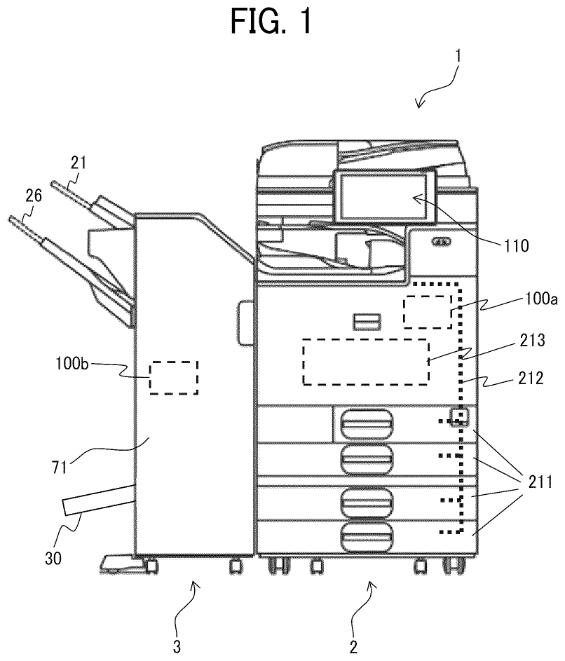

A description is given below of an image forming system 1 with reference to the drawings. FIG. 1 is a diagram illustrating an overall configuration of the image forming system 1. The image forming system 1 has a function of forming an image on a sheet P as a sheet medium and a function of performing a post-processing operation on the sheet P as a process after the image is formed on the sheet P. As illustrated in FIG. 1, the image forming system 1 includes an image forming apparatus 2 having the image forming function and a post-processing apparatus 3 serving as a media processing apparatus having the post-processing function. In the image forming system 1, the image forming apparatus 2 and the post-processing apparatus 3 operate in conjunction with each other.

In the present embodiment, the sheet-shaped medium to be processed in the image forming system 1 is assumed to be a sheet of “paper.” However, the object to be processed according to the present embodiment is not limited to a sheet of paper. For example, any type of medium can be used as long as an image can be formed on the medium according to an image forming process. Examples of the medium include a medium that can be an object of a folding process or a binding process, and the material and specification of the medium are not limited to any particular material and specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using ink or an electrophotographic system that forms an image using toner. The image forming apparatus 2 also includes a controller 100a that controls various operations of the conveyor 212 and the image forming device 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P.” Further, in the following description, a bundle of sheets of paper as a plurality of media is an example of a “sheet bundle Pb.”

A description is given below of a post-processing apparatus 3 according to a first embodiment.

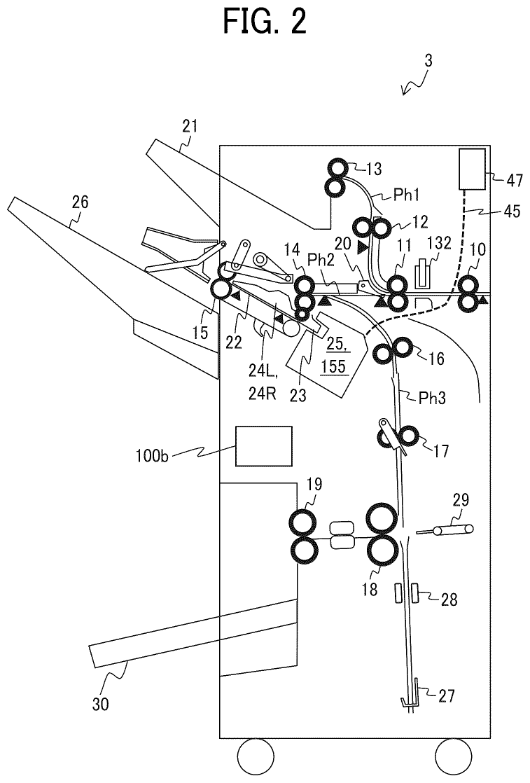

FIG. 2 is a diagram illustrating an internal configuration of the post-processing apparatus 3 according to the first embodiment. The post-processing apparatus 3 has a function that performs post-processing on the sheet P on which an image has been formed by the image forming apparatus 2. An example of the post-processing according to the present embodiment is a binding process as a “crimping process” that binds, without staples, a plurality of sheets P on each of which an image is formed as a bundle of sheets, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets P may be referred to as a “sheet bundle Pb” as a stack of media.

In the present embodiment, a description is given of liquid application in a crimping process. However, liquid application performed in a stapling process is similar to the liquid application in the crimping process. In the following description, the term “binding process” indicates both the “crimping process” and the “stapling process”, and is not limited to a binding method (whether a binding needle is used or a pressing and deforming process is performed).

More specifically, the “crimping process” according to the present embodiment is a process in which pressure is applied to a binding position corresponding to a part of a sheet bundle Pb, the binding position is deformed (pressure-deformed), and fibers of overlapping sheets P are entangled with each other, thus binding the sheets P together. The crimping process partially binds the overlapping portions of the sheets P together to form a sheet bundle Pb. This crimping process may be referred to as “crimping” in the following description. The binding process ((including both crimping and stapling) that is executable by the post-processing apparatus 3 includes edge binding and saddle binding. The edge binding is a process to bind an end (including an edge) of the sheet bundle Pb. The saddle binding (center binding) is a process to bind the center of the sheet bundle Pb.

The post-processing apparatus 3 includes conveyance roller pairs 10 to 19 (an example of conveyors), a switcher 20, and a controller 100b (an example of a control device). The controller 100b controls the operations of, for example, the conveyance roller pairs 10 to 19 (an example of conveyors), and the switcher 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in the conveyance direction of the sheet and extending to a second ejection tray 26 via the internal tray 22. The third conveyance passage Ph3 is a passage branching from the first conveyance passage Ph1 between the conveyance roller pairs 11 and 14 in the conveyance direction of the sheet and extending to a third ejection tray 30.

The switcher 20 is disposed at a branching position of the first conveyance passage Ph1 and the second conveyance passage Ph2. The switcher 20 can be switched between a first position and a second position. The switcher 20 in the first position guides the sheet P to be ejected to the first ejection tray 21 through the first conveyance passage Ph1. The switcher 20 in the second position guides the sheet P conveyed through the first conveyance passage Ph1 to the second conveyance passage Ph2. At the timing when the trailing end of the sheet P entering the second conveyance passage Ph2 passes between the rollers of the conveyance roller pair 11, the conveyance roller pair 14 is rotated in the reverse direction so that the sheet P is guided to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the sensors is indicated by a black triangle in FIG. 2.

The post-processing apparatus 3 includes a first ejection tray 21. The sheet P that is output through the first conveyance passage Ph1 is placed on the first ejection tray 21. Among the sheets P supplied from the image forming apparatus 2, the sheet P on which the binding operation is not performed is ejected to the first ejection tray 21.

The post-processing apparatus 3 further includes the internal tray 22 serving as a placement tray, an edge-binding end fence 23, side fences 24L and 24R, an edge binder 25, a staple binder 155, and a second ejection tray 26. The internal tray 22, the edge-binding end fence 23, the side fences 24L and 24R, the edge binder 25, and the staple binder 155 perform edge binding on the sheet bundle Pb including the multiple sheets P conveyed from the second conveyance passage Ph2 to the internal tray 22. Among the sheets P supplied from the image forming apparatus 2, the sheet bundle Pb subjected to the edge binding is ejected to the second ejection tray 26.

The “edge binding process” here means a binding process performed by the edge binder 25 and the staple binder 155. Specifically, the “edge binding process” includes, but not limited to, a “parallel binding process” that binds the sheet bundle Pb along one side of the sheet bundle Pb parallel to the main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction.” In other words, the “conveyance direction” in the present specification corresponds to a direction in which the sheet P output from the image forming apparatus 2 is moved toward the second ejection tray 26 by, for example, the conveyance roller pair 10 and is then changed by the conveyance roller pair 15 to move toward the edge-binding end fence 23 as a direction different from the direction toward the second ejection tray 26. A direction orthogonal to the thickness direction and the conveyance direction of the paper P is defined as a “main scanning direction” or a “width direction”.

The sheets P that are sequentially conveyed through the second conveyance passage Ph2 are temporarily placed on the internal tray 22 serving as a placement tray. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the edge-binding end fence 23 and the side fences 24L and 24R. The conveyance roller pair 15 ejects the sheet bundle Pb subjected to the edge binding to the second ejection tray 26.

The post-processing apparatus 3 further includes a saddle-binding end fence 27, a saddle binder 28, a sheet folding blade 29, and the third ejection tray 30. The saddle-binding end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the third ejection tray 30.

The saddle-binding end fence 27 aligns the positions of the sheets P that are sequentially conveyed through the third conveyance passage Ph3, in a direction in which the sheets P are conveyed. The saddle-binding end fence 27 can move between a binding position where the saddle-binding end fence 27 causes the center of the sheet bundle Pb to face the saddle binder 28 and a folding position where the saddle-binding end fence 27 causes the center of the sheet bundle Pb to face the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pairs 18 and 19 eject the sheet bundle Pb subjected to the saddle binding to the third ejection tray 30.

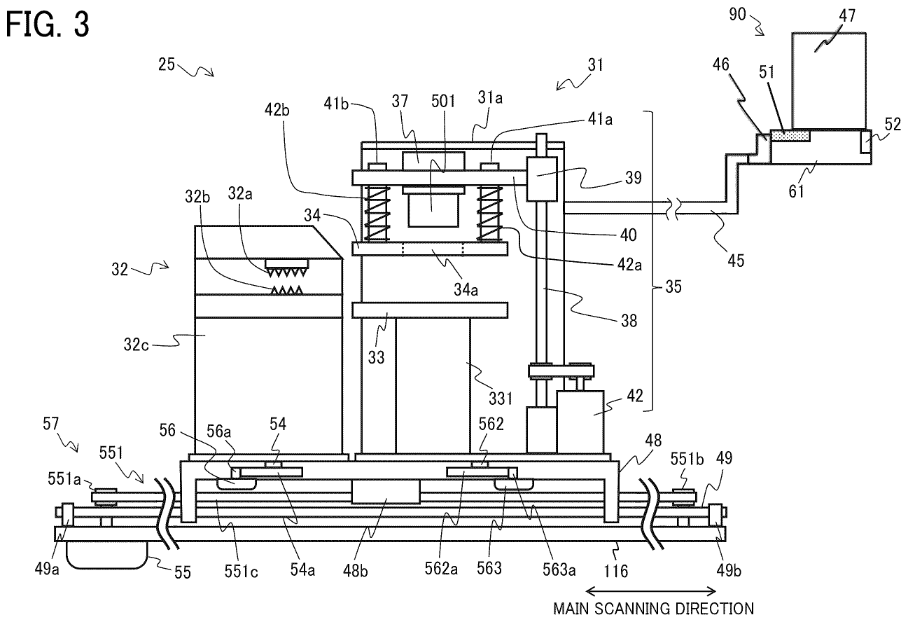

In addition, the post-processing apparatus 3 includes the liquid application member 501 (a part of the liquid applier), the liquid supply member 50 (a part of the liquid applier), and the first liquid storage tank 44 (the first liquid storage) in the edge binder 25. The first liquid storage tank 44 and the liquid supply member 50 are omitted in FIG. 3. The post-processing apparatus 3 includes a liquid supply passage 45 (a part of a liquid supplier), a liquid supply pump 46 (a part of the liquid supplier), a second liquid storage tank 47 (a part of a second liquid storage), and a second-liquid-storage-tank fixer 61 (a part of the second liquid storage) as a configuration for replenishing the first liquid storage tank 44 with the liquid. The liquid that is stored in the second liquid storage tank 47 is supplied to the first liquid storage tank 44 through the second-liquid-storage-tank fixer 61, the liquid supply pump 46, and the liquid supply passage 45.

A detailed description is given below of the edge binder 25.

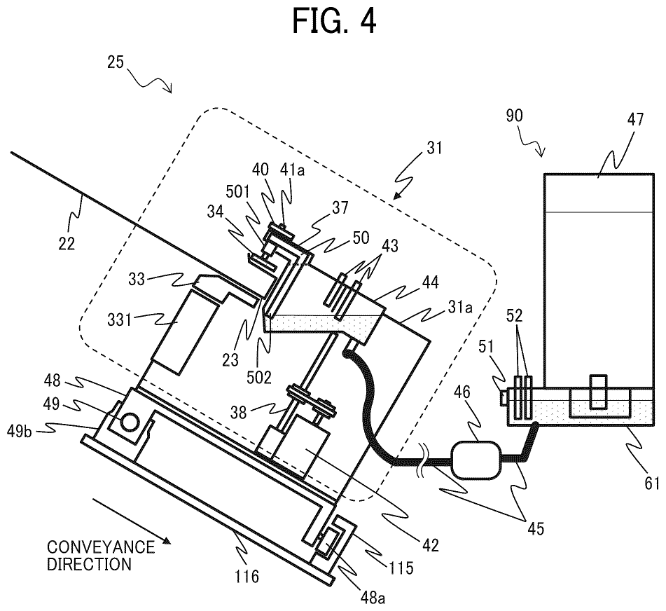

FIG. 3 is a schematic diagram illustrating an upstream side of the edge binder 25 in the conveyance direction. The edge binder 25 performs liquid application and crimping illustrated in FIG. 2. FIG. 4 is a schematic view of a liquid applier 31 of the edge binder 25 in the main scanning direction. As illustrated in FIG. 3, the edge binder 25 includes a liquid applier 31 that applies liquid to the paper P or the sheet bundle Pb, and a crimper 32 that is an example of a post-processing device and performs crimping on the sheet bundle Pb to bind the sheet bundle Pb. The liquid applier 31 and the crimper 32 are disposed adjacent to each other in the main scanning direction downstream from the internal tray 22 in the conveyance direction.

As illustrated in FIG. 4, the liquid applier 31 applies the liquid stored in the first liquid storage tank 44 to the sheet P or the sheet bundle Pb placed on the internal tray 22. Applying liquid to a sheet P or a sheet bundle Pb by the liquid applier 31 and the operation of the liquid applier 31 when applying liquid are referred to as “liquid application”. The liquid application operation of the liquid applier 31 accompanied by the control process is referred to as a “liquid application process”.

More specifically, the liquid that is stored in the first liquid storage tank 44 as liquid for the “liquid application” includes, as a main component, the liquid state of a compound of hydrogen and oxygen compound represented by the chemical formula H2O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 44 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

A description is given of a configuration of the liquid applier 31.

As illustrated in FIGS. 3 and 4, the liquid applier 31 can be moved in the main scanning direction together with the crimper 32 by the driving force transmitted from the edge-binder movement motor 55. The liquid applier 31 includes a lower pressure plate 33 as a sheet stacking table of the sheet P or the sheet bundle Pb, an upper pressure plate 34, and a liquid-applier movement assembly 35. The components of the liquid applier 31 (the lower pressure plate 33, the upper pressure plate 34, the liquid-applier movement assembly 35, and the liquid-applier movement motor 42) are held by the liquid application frame 31a and the base 48.

A liquid-applier rotation shaft 562 provided with a drive transmission gear 562a is fixed to a bottom face of the liquid application frame 31a that holds the components of the liquid applier 31. The liquid-applier rotation shaft 562 and the drive transmission gear 562a are held by the base 48 on which the liquid application frame 31a is disposed, so as to be rotatable in the forward and reverse directions. The drive transmission gear 562a meshes with an output gear 563a of the liquid-applier pivot motor 563. The liquid applier 31 can be rotated in the forward and reverse directions about the liquid-applier rotation shaft 562 on the base 48 by a driving force transmitted from the liquid-applier pivot motor 563 to the liquid-applier rotation shaft 562 via the output gear 563a and the drive transmission gear 562a.

The lower pressure plate 33 and the upper pressure plate 34 are disposed downstream from the internal tray 22 in the conveyance direction. The sheet P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 501 held via a holder 37 attached to a base plate 40. The liquid application member 501 is one end portion of a liquid supply member 50 (liquid absorber) described below and corresponds to a tip portion of the liquid supply member 50.

The liquid-applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid-applier movement assembly 35 according to the embodiment moves the upper pressure plate 34, the base plate 40, the holder 37, the liquid application member 501, the liquid supply member 50, and the first liquid storage tank 44 in conjunction with each other by the single liquid-applier movement motor 42. The liquid-applier movement assembly 35 includes, for example, the liquid-applier movement motor 42, a trapezoidal screw 38, a nut 39, the base plate 40, columns 41a and 41b, and coil springs 42a and 42b.

The liquid-applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid-applier movement motor 42 via, for example, a pulley and a belt. The nut 39 is screwed to the trapezoidal screw 38. The trapezoidal screw 38 is rotated in the forward and reverse directions by the driving force transmitted from the liquid-applier movement motor 42. The rotation of the trapezoidal screw 38 causes the nut 39 to reciprocate on the trapezoidal screw 38.

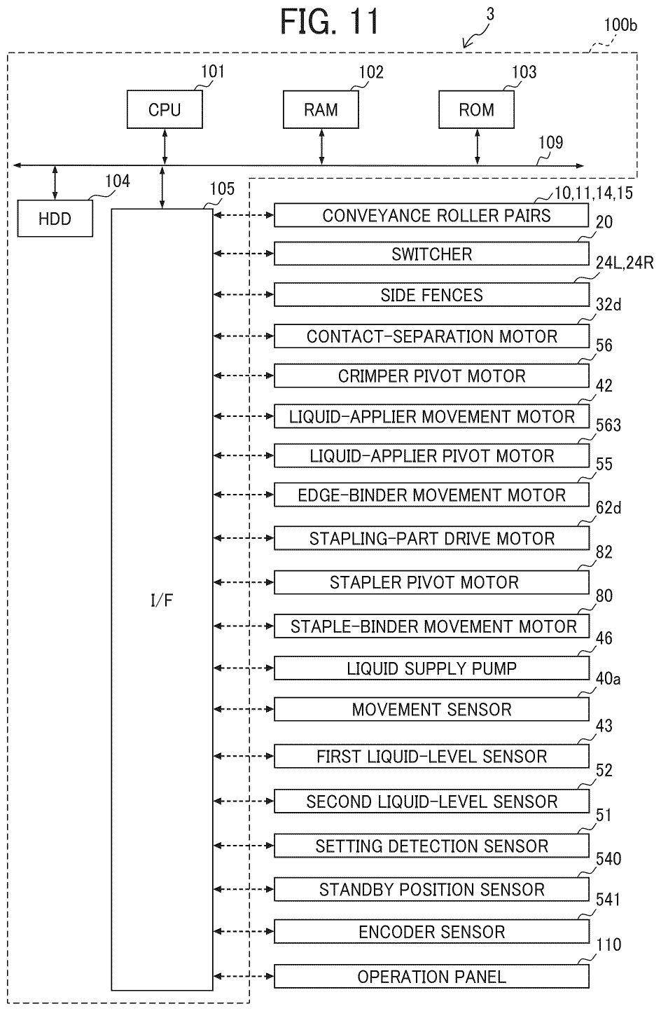

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that the base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 11).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More specifically, the liquid applier 31 brings the liquid application member 501 into contact with the sheet P or the sheet bundle Pb to apply the liquid to at least one sheet P of the sheet bundle Pb.

The liquid applier 31 includes a first liquid-level sensor 43 (a first liquid detector), the first liquid storage tank 44, the liquid application member 501, the liquid supply member 50, and the holder 37. The first liquid storage tank 44 stores the liquid for performing liquid application on the sheet P or the sheet bundle Pb. The liquid stored in the first liquid storage tank 44 is detected by the first liquid-level sensor 43. The first liquid storage tank 44 is coupled to the base plate 40 via the holder 37.

The liquid application member 501 applies the liquid stored in the first liquid storage tank 44 to the sheet P or the sheet bundle Pb. The liquid application member 501, the liquid supply member 50 (liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, the material may be any material as long as the material can absorb or draw up liquid by capillary action.

Accordingly, when the second end (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from the liquid immersion portion 502 of the liquid supply member 50, and the sucked liquid is supplied to the liquid application member 501 that is coupled to the tip portion via the liquid supply member 50. Then, the liquid stored in the first liquid storage tank 44 is sucked up to the liquid application member 501 in close contact with one end portion of the liquid supply member 50, and thus the liquid level (stored liquid amount) of the liquid stored in the first liquid storage tank 44 detected by the first liquid-level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (e.g., a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. Accordingly, the amount of liquid (liquid level) in the first liquid storage tank 44 temporarily decreases to a level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is typically performed at the time of activation of the post-processing apparatus 3 or at the time of start of execution of the binding processing involving liquid application in the post-processing apparatus 3, and corresponds to the liquid supply operations for bringing the liquid application using the liquid application member 501 to be executable.

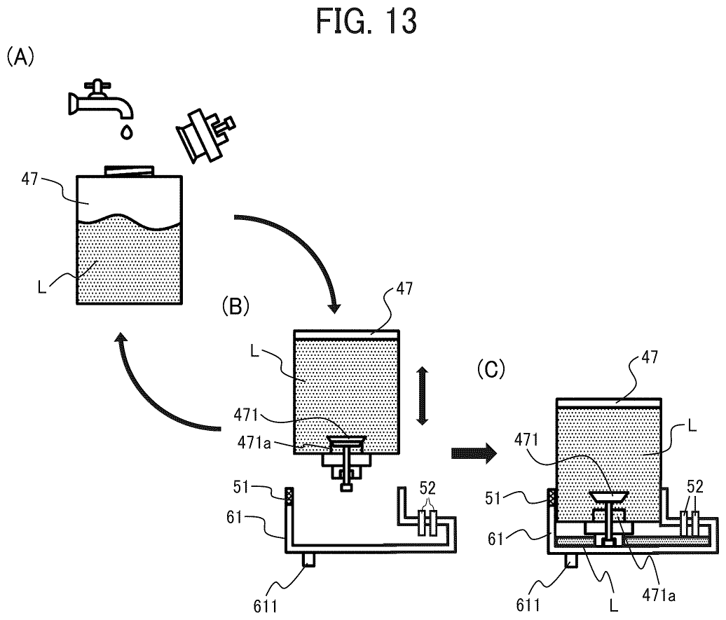

The edge binder 25 or the post-processing apparatus 3 is provided with the second liquid storage tank 47. The second liquid storage tank 47 is detachably attached to the second-liquid-storage-tank fixer 61 (a part of the second liquid storage) disposed in the edge binder 25 or the post-processing apparatus 3 (see part (A) of FIG. 13). When the second liquid storage tank 47 is fixed (set) to the second-liquid-storage-tank fixer 61 (a part of the second liquid storage) in a given position, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by the liquid application by the liquid applier 31. In other words, the operation of supplying liquid from the second liquid storage tank 47 to the first liquid storage tank 44 corresponds to the liquid supply operation needed with the execution of the job including the liquid application by the liquid applier 31.

This liquid supply operation corresponds to an operation of supplying liquid to the first liquid storage tank 44 so as to add liquid each time the stored liquid amount (liquid level) of the first liquid storage tank 44 falls below the reference liquid level, which is described below.

The above-described “reference liquid level” indicates a liquid level (a stored liquid amount in the first liquid storage tank 44) when the first liquid-level sensor 43 detects the liquid in the first liquid storage tank 44.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (a setting detector) (see part (B) of FIG. 13). When the setting detection sensor 51 detects the set state of the second liquid storage tank 47 to the second-liquid-storage-tank fixer 61 (see part (C) of FIG. 13), a signal indicating the set state is transmitted to the controller 100b, which is described below. Thus, the controller 100b detects whether the second liquid storage tank 47 is set on the second-liquid-storage-tank fixer 61. Details of the second liquid storage tank 47 are described later.

The first liquid storage tank 44 and the second liquid storage tank 47 are connected to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid-applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid-level sensor 43. In other words, the controller 100b, which is described below, determines whether the stored liquid amount (liquid level) in the first liquid storage tank 44 based on the detection result of the first liquid-level sensor 43. In accordance with the determined stored liquid amount (liquid level) of the first liquid storage tank 44, the controller 100b controls the operation speed and time of the liquid supply pump 46. Thus, the controller 100b can adjust the amount of liquid to be replenished to the first liquid storage tank 44 to maintain the amount (liquid level) of liquid in the first liquid storage tank 44 at a constant level.

A description is given of the configuration of the crimper 32.

As illustrated in FIG. 3, the crimper 32 as a post-processing device presses and deforms at least a portion (i.e., liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In short, the crimper 32 binds the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimping.” In other words, the crimper 32 crimps and binds the sheet bundle Pb or performs the crimping on the sheet bundle Pb. The crimping and binding operation of the crimper 32 that involves control processing is referred to as “crimping process”.

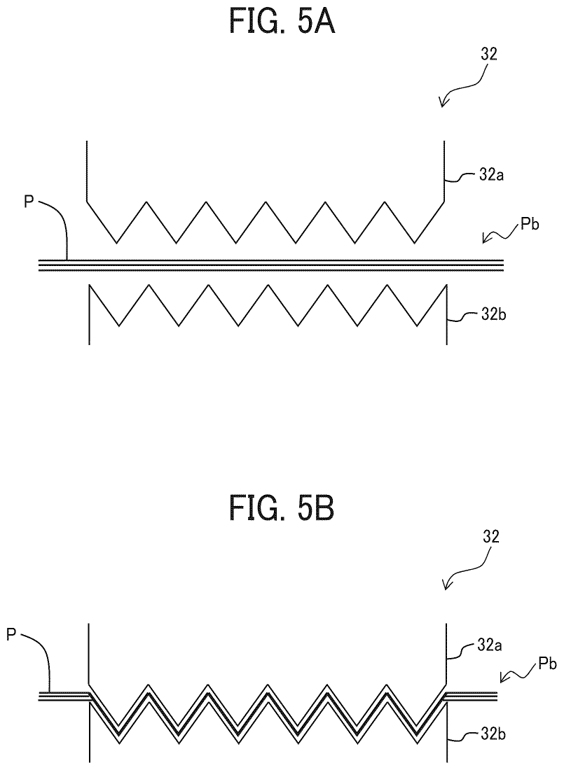

FIGS. 5A and 5B are schematic diagrams illustrating a configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by a driving force of a contact-separation motor 32d illustrated in FIG. 11.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of an operating assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may be a linear-motion-type crimping assembly that linearly performs crimping and separating operations of the upper crimping teeth 32a and the lower crimping teeth 32b with a screw assembly that converts the forward and backward rotational motions of a driving source into linear reciprocating motion.

As illustrated in FIG. 3, the edge binder 25 includes an edge-binder movement assembly 57. The edge-binder movement assembly 57 moves the edge binder 25, specifically, the liquid applier 31 and the crimper 32, in the main scanning direction along a downstream end, in the conveyance direction, of the sheet P placed on the internal tray 22. The edge-binder movement assembly 57, which is an example of a liquid application mover, includes, for example, the base 408, a guide shaft 49, the edge-binder movement motor 55, and a driving force transmission assembly 551 that transmits the driving force of the edge-binder movement motor 55 to the base 48, and a standby position sensor 540 (see FIG. 11).

The liquid applier 31 and the crimper 32 are attached to the base 48 such that the liquid applier 31 and the crimper 32 are adjacent to each other in the main scanning direction. As illustrated in FIGS. 3 and 4, the guide shaft 49 is disposed in the main scanning direction on the upstream side of a binding assembly base 116 in the conveyance direction and is held by multiple guide shaft brackets 49a and 49b. The guide shaft 49 is disposed to extend in the main scanning direction on the binding assembly base 116, and holds the base 48 to be movable in the main scanning direction. As illustrated in FIG. 4, the guide rail 115 is disposed in the downstream side of the binding assembly base 116 in the conveyance direction and extends in the main scanning direction. The guide rail 115 has a to-be-fitted portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge-binder movement motor 55 generates a driving force to move the edge binder 25. The driving force transmission assembly 551 transmits the driving force of the edge-binder movement motor 55 to the base 48 via pulleys 551a and 551b, a timing belt 551c, and a fastening portion 48b that fastens the base 408 and the timing belt 551c. As a result, the liquid applier 31 and the crimper 32 integrated by the base 408 move in the main scanning direction along the guide shaft 49.

The edge-binder movement motor 55 according to the present embodiment is, for example, a servo motor that can stop the edge binder 25 at a target position (the first binding position B1 and a second binding position B2 described below) without returning the edge binder 25 to an origin position (for example, a standby position HP described below) each time the edge binder 25 moves.

The post-processing apparatus 3 further includes a standby position sensor 540 and an encoder sensor 541. The standby position sensor 540 is, for example, a light-shielding optical sensor (see FIG. 11) to detect that the edge binder 25 has reached a standby position

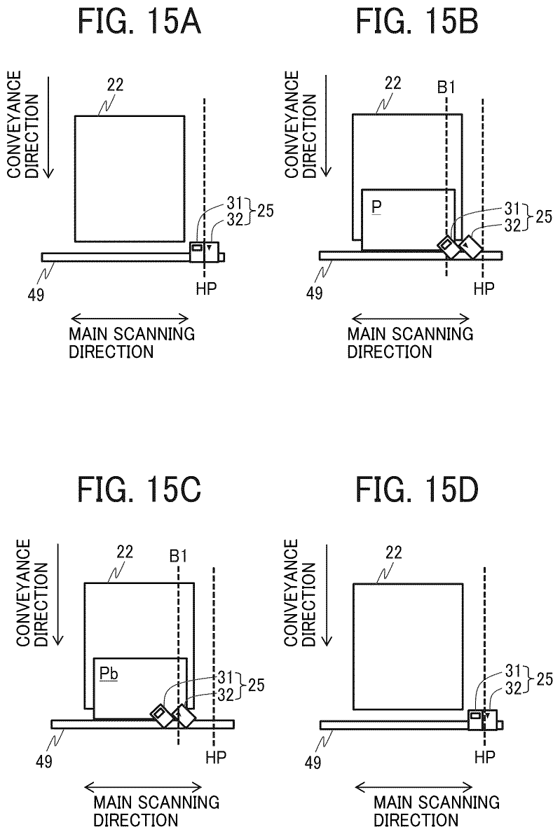

HP (see FIGS. 15A and 15D). The encoder sensor 541 (see FIG. 11) is attached to an output shaft of the edge-binder movement motor 55. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper rotation shaft 54 provided with a drive transmission gear 54a is fixed to a bottom face of the crimping frame 32c that holds the components of the crimper 32. The crimper rotation shaft 54 and the drive transmission gear 54a are held by a base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper rotation shaft 54 on the base 48 by a driving force transmitted from the crimper pivot motor 56 to the crimper rotation shaft 54 via the output gear 56a and the drive transmission gear 54a.

In the above description, the edge binder 25 has a configuration of moving along the guide shaft 49 with the crimper 32 and the liquid applier 31 being integrated. However, the present disclosure is not limited to the above-described configuration. For example, the crimper 32 and the liquid applier 31 may have a configuration of moving separately from each other.

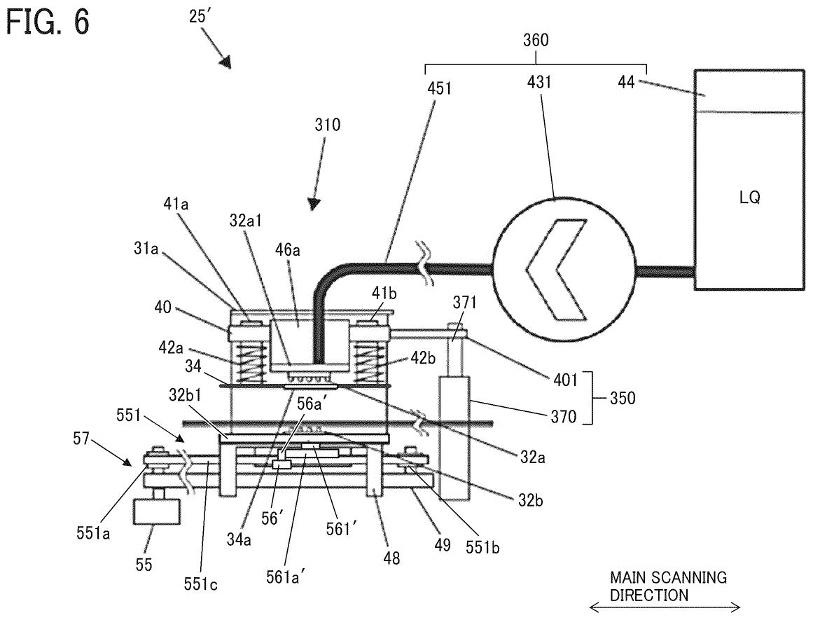

A description is given below of an edge binder 25′ according to a modification. Specifically, referring now to FIGS. 6 to 8C, a description is given of an edge binder 25′ as a modification of the edge binder 25 included in the post-processing apparatus 3. A difference of the edge binder 25′ from the edge binder 25 according to the first embodiment is that the liquid applier 31 and the crimper 32 are integrated as a single unit. In the following description, identical or similar components to those of the edge binder 25 according to the first embodiment are denoted by identical or similar reference signs, and redundant descriptions thereof may be omitted.

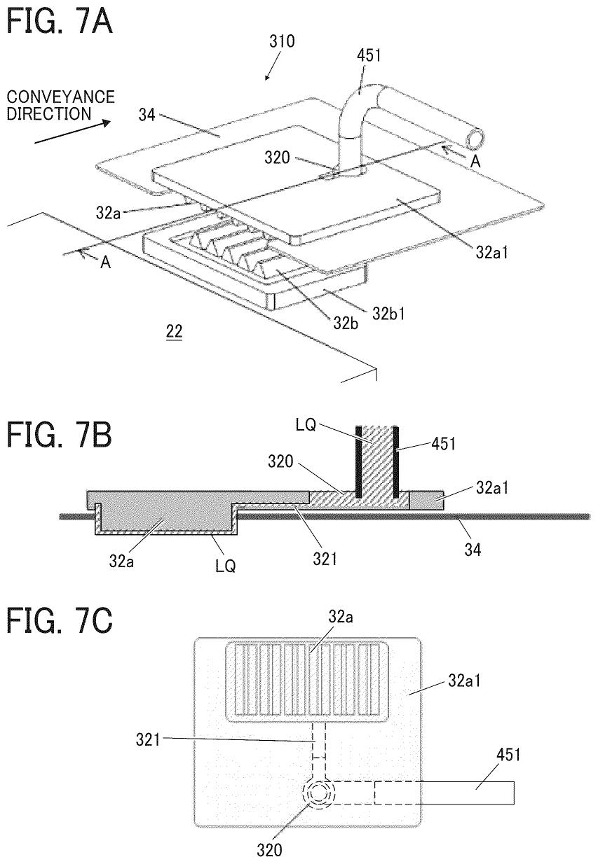

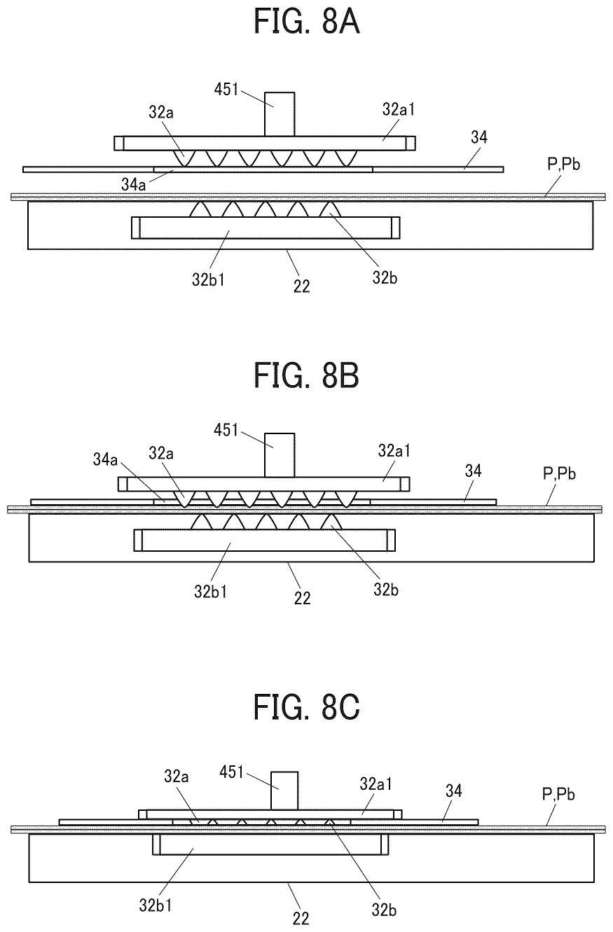

FIG. 6 is a schematic view of the edge binder 25′ viewed from the upstream side in the conveyance direction. FIG. 7A is a perspective view of a liquid application crimper 310. FIG. 7B is a sectional view of the liquid application crimper 310 taken along line A-A in FIG. 7A. FIG. 7C is a plan view of the upper crimping teeth 32a of FIG. 7A as viewed from the side at which the lower crimping teeth 32b are disposed. FIGS. 8A, 8B, and 8C illustrate a liquid application operation and a crimping operation performed by the liquid application crimper 310 and are schematic views of the liquid application crimper 310 viewed from the downstream side in the conveyance direction.

As illustrated in FIG. 6, the edge binder 25′ includes the liquid application crimper 310 in which the liquid applier 31 and the crimper 32 (an example of a post-processing device) of the edge binder 25 according to the first embodiment are integrated as a single unit. The liquid application crimper 310 is disposed downstream from the internal tray 22 in the conveyance direction.

The liquid application crimper 310 applies liquid LQ stored in the first liquid storage tank 44 to a sheet P or a sheet bundle Pb placed on the internal tray 22. The liquid application crimper 310 can be moved in the main scanning direction by the driving force that is transmitted from the edge-binder movement motor 55 to the base 48 by the driving force transmission assembly 551. The liquid application crimper 310 includes the upper pressure plate 34, the upper crimping teeth 32a, the lower crimping teeth 32b, a liquid-application-crimper movement assembly 350, and a liquid supply assembly 360. Components of the liquid application crimper 310 are held by the liquid application frame 31a and the base 48. A liquid-application-crimper rotation shaft 561′ provided with a drive transmission gear 561a′ is fixed to a bottom face of the liquid application frame 31a. The liquid-application-crimper rotation shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid-application-crimper pivot motor 56′. The liquid application crimper 310 can be rotated in the forward and reverse directions about the liquid-application-crimper rotation shaft 561′ on the base 48 by a driving force transmitted from the liquid-application-crimper pivot motor 56′ to the liquid-application-crimper rotation shaft 561′ via the output gear 56a′ and the drive transmission gear 561a′.

The liquid-application-crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds the upper crimping teeth holder 32al and the upper crimping teeth 32a via a holder 46a. The base plate 40 movably holds the upper pressure plate 34 via the columns 41a and 41b. The base plate 40 is attached to the distal end of a rod 371 of the electric cylinder 370 via a connecter 401.

The columns 41a and 41b hold the upper pressure plate 34 at lower ends of the columns 41a and 41b. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid supply pump 431, and a first liquid supply passage 451. The liquid supply pump 431 supplies the liquid LQ to the liquid reservoir 320 disposed in the upper crimping teeth holder 32al as illustrated in FIG. 7A via the first liquid supply passage 451. The first liquid supply passage 451 is coupled to the liquid supply pump 431 at the base end and to the liquid reservoir 320 at the tip end. The first liquid supply passage 451 includes a long and elastic member.

As illustrated in FIG. 7B, the upper crimping teeth 32a are integrated with the upper crimping teeth holder 32a1. The upper crimping teeth holder 32al is provided with the liquid reservoir 320 and a liquid supply passage 321 that supplies the liquid LQ stored in the liquid reservoir 320 to the upper crimping teeth 32a. The surface of the upper crimping teeth 32a is subjected to hydrophilic treatment so that the liquid LQ that is supplied through the liquid supply passage 321 uniformly spreads over the surface of the upper crimping teeth 32a. On the other hand, the portion of the upper crimping teeth holder 32al other than the upper crimping teeth 32a is subjected to hydrophobic treatment so that the liquid LQ efficiently spreads over the surface of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

A description is given below of the liquid application operation and the crimping operation of the liquid application crimper 310 with reference to FIGS. 8A, 8B, and 8C. In the process of supplying a sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through-hole 34a of the upper pressure plate 34 and come into contact with the sheet P. At this time, since the liquid LQ is spread over the surfaces of the upper crimping teeth 32a, bringing the upper crimping teeth 32a into contact with the sheet P allows the liquid to be applied to the liquid application position on the sheet P. When liquid application to the liquid application position is completed, the electric cylinder 370 is extended to separate the upper crimping teeth 32a and the upper pressure plate 34 from the sheet P. The above-described contact and separation operation (liquid application operation) of the upper crimping teeth 32a and the upper pressure plate 34 with respect to the sheets P is repeatedly performed on sheets P of the sheet bundle Pb.

When the sheet bundle Pb including a predetermined number of sheets P is placed on the internal tray 22, the electric cylinder 370 is further contracted to move the upper crimping teeth 32a toward the lower crimping teeth 32b. Then, as illustrated in FIG. 8C, the upper crimping teeth 32a further moves toward the lower crimping teeth 32b, with the sheet bundle Pb sandwiched between the upper crimping teeth 32a and the lower crimping teeth 32b. Thus, the upper crimping teeth 32a and the lower crimping teeth 32b press and deform the sheet bundle Pb to crimp and bind the sheet bundle Pb (crimping operation).

A description is given of a staple binder 155.

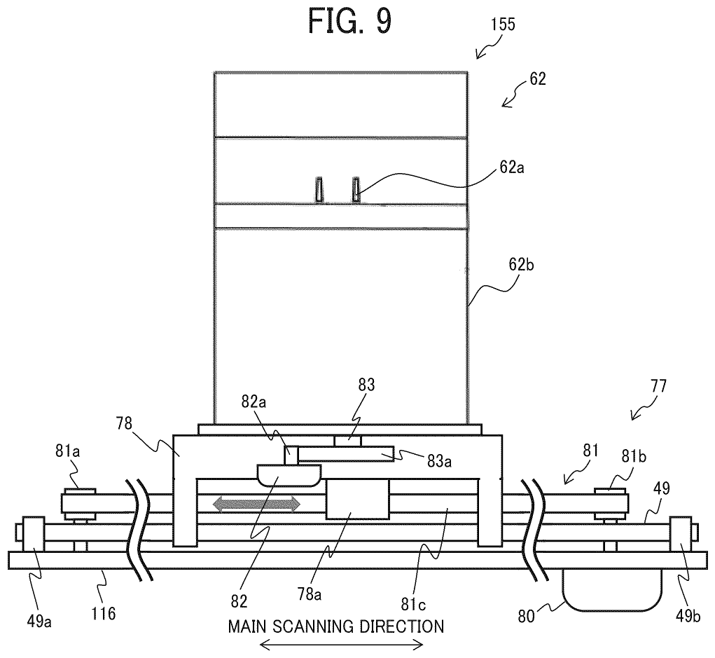

Specifically, a detailed description is given below of the staple binder 155 having a function of executing a stapling process. FIG. 9 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “staple binding” to bind a sheet bundle Pb with a staple(s). More specifically, the stapler 62 includes a stapling-part drive motor 62d (see FIG. 11) that drives a stapling part 62a. The stapling part 62a binds the sheet bundle Pb by causing the binding staple loaded in the stapling part 62a to penetrate the sheet bundle Pb by the driving force of the stapling-part drive motor 62d. The stapler 62 may have a known structure, and thus detailed descriptions thereof will be omitted.

As illustrated in FIG. 9, the staple binder 155 includes a staple-binder movement assembly 77. The staple-binder movement assembly 77 moves the staple binder 155 in the main scanning direction along a downstream end in the conveyance direction of the sheet Por the sheet bundle Pb placed on the internal tray 22. The staple-binder movement assembly 77 includes, for example, a base 78, the guide shaft 49, a staple-binder movement motor 80, and a driving force transmission assembly 81. The driving force transmission assembly 81 transmits a driving force of the staple-binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge-binder movement assembly 57 and the staple-binder movement assembly 77 move the edge binder 25 and the staple binder 155 in the main scanning direction along the common guide shaft 49. The edge-binder movement assembly 57 and the staple-binder movement assembly 77 can independently move the edge binder 25 and the staple binder 155.

A description is given below of a modification of the staple binder 155.

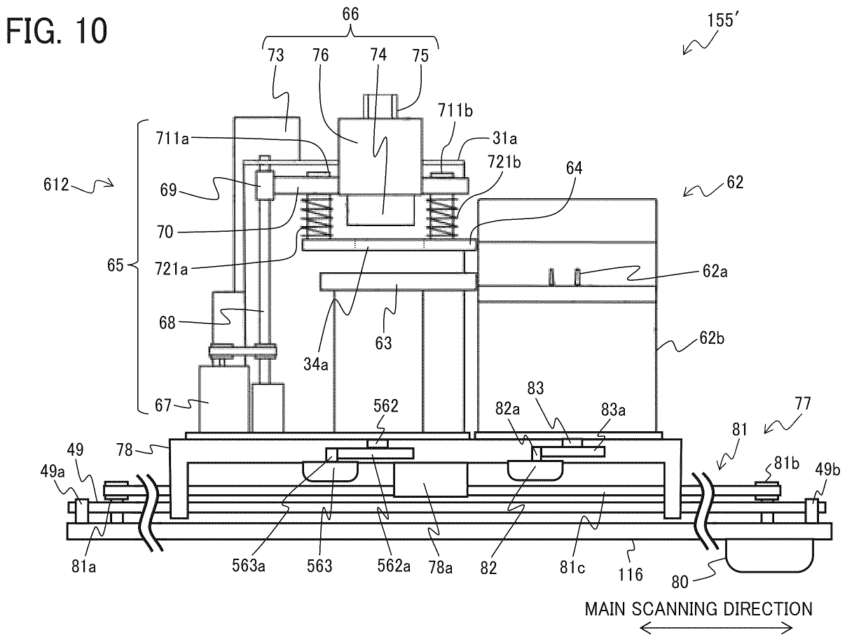

FIG. 10 illustrates a staple binder 155′ as a modification of the staple binder 155. Specifically, FIG. 10 is a view of an upstream side of the staple binder 155′ in the conveyance direction. The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 performs the liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid-applier movement assembly 65, and a second liquid application assembly 66. The second liquid-applier movement assembly 65 includes, for example, a second liquid-applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid application member 74, a second liquid supply member 75, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the stapler 62 has a configuration similar to the configuration of the staple binder 155 illustrated in FIG. 9, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid-applier pivot motor 563, an output gear 563a, a drive transmission gear 562a, and a liquid-applier rotation shaft 562.

In the binding process, the staple binder 155′ that is illustrated in FIG. 10 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without performing the liquid application.

A description is given below of control blocks of the post-processing apparatus 3. A description is given below of a control block of the post-processing apparatus 3, with reference to FIG. 11. FIG. 11 is a block diagram illustrating a hardware configuration for executing control processing in the post-processing apparatus 3. As illustrated in FIG. 11, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b, which is an example of a control device, to control the operation of the post-processing apparatus 3.

The I/F 105 is an interface that connects the conveyance roller pairs 10, 11, 14, and 15, the switcher 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, the liquid supply pump 46, the movement sensor 40a, the first liquid-level sensor 43, the second liquid-level sensor 52, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switcher 20, the side fences 24L and 24R, the contact-separation motor 32d, the crimper pivot motor 56, the liquid-applier movement motor 42, the liquid-applier pivot motor 563, the edge-binder movement motor 55, the stapling-part drive motor 62d, the stapler pivot motor 82, the staple-binder movement motor 80, and the liquid supply pump 46. The controller 100b acquires detection results from the movement sensor 40a, the first liquid-level sensor 43, the second liquid-level sensor 52, the setting detection sensor 51, the standby position sensor 540, and the encoder sensor 541.

Although FIG. 11 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation device includes, for example, hard keys and a touch screen overlaid on the display. The operation panel 110 acquires information from the user through the operation section and provides information to the user through the display. A specific example of the notifier is not limited to the display and may be a light-emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

The liquid application executed by the post-processing apparatus 3 may be performed by the staple binder 155 including the stapler 62 only, and the liquid application may be performed by using the liquid applier 31 included in the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration in which the stapler 62 and the second liquid applier 612 move along the guide shaft 49 as a single unit. However, the configuration of the staple binder is not limited to the above-described configuration. For example, the stapler 62 and the second liquid applier 612 may move separately.

A detailed description is given below of the second liquid storage tank 47.

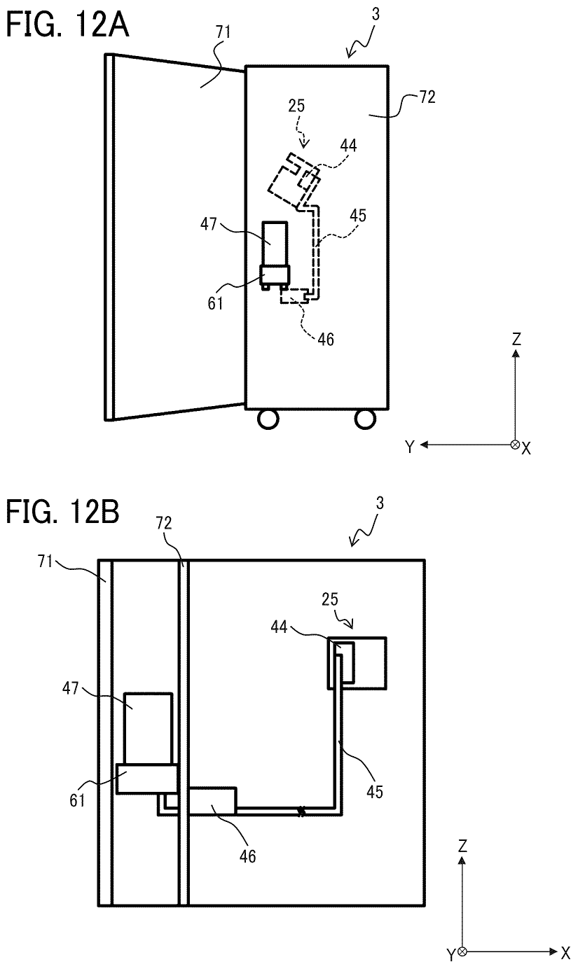

Referring now to FIGS. 12A, 12B, and 13, a description is given of the arrangement and configuration of the second liquid storage tank 47 in the post-processing apparatus 3. FIGS. 9A and 9B illustrate an example arrangement and configuration of the second liquid storage tank 47 as the main tank. FIG. 12A illustrates the post-processing apparatus 3 with a cover 711 opened. FIG. 12B is a sectional side view of the post-processing apparatus 3, illustrating the post-processing apparatus 3 with the cover 711 closed. As illustrated in FIG. 12A, the second liquid storage tank 47 is located so as to be accessible when the cover 711 of the post-processing apparatus 3 is opened. As illustrated in FIG. 12B, the second liquid storage tank 47 and the second-liquid-storage-tank fixer 61 are disposed on the near side in a depth direction (X direction) of the post-processing apparatus 3.

The first liquid storage tank 44 is disposed on the far side in the depth direction (X direction) of the post-processing apparatus 3. A housing side plate 712 of the post-processing apparatus 3 is disposed between the location of the second liquid storage tank 47 and the second-liquid-storage-tank fixer 61 and the location of the first liquid storage tank 44 and so forth. The second-liquid-storage-tank fixer 61 is attached to the housing side plate 712 of the post-processing apparatus 3.

FIG. 13 illustrates a state in which the second liquid storage tank 47 is attachable to and detachable from the second-liquid-storage-tank fixer 61 and a state in which liquid Lis replenished to the second liquid storage tank 47. As illustrated in part (A) of FIG. 13, the second liquid storage tank 47 is attachable to and detachable from the second-liquid-storage-tank fixer 61 so as to replenish the first liquid storage tank 44 with liquid. As illustrated in part (B) of FIG. 13, the second-liquid-storage-tank fixer 61 is provided with the setting detection sensor 51 serving as a setting detector that detects that the second liquid storage tank 47 is set on the second-liquid-storage-tank fixer 61.

When the setting detection sensor 51 detects the set state of the second liquid storage tank 47 to the second-liquid-storage-tank fixer 61 (see part (C) of FIG. 13), a signal indicating the set state is transmitted to the controller 100b. Thus, the controller 100b detects whether the second liquid storage tank 47 is set on the second-liquid-storage-tank fixer 61.

The second liquid-level sensor 94 (a second liquid detector) that detects the amount of liquid L stored in the second liquid storage tank 47 is disposed in the second-liquid-storage-tank fixer 61. The output value (voltage) of the second liquid-level sensor 94 is notified to the controller 100b. The controller 100b determines the output value (voltage) of the second liquid-level sensor 94 to determine whether the amount of liquid stored in the second-liquid-storage-tank fixer 61 is a required amount of liquid. When the controller 100b determines that the second liquid storage tank 47 is set on the second-liquid-storage-tank fixer 61 (i.e., is in a set state) based on the output signal of the setting detection sensor 51, the controller 100b turns on the second liquid-level sensor 94 such that the remaining amount of liquid (the amount of the liquid stored) in the second-liquid-storage-tank fixer 61 can be detected.

When the second liquid storage tank 47 is not set on the second-liquid-storage-tank fixer 61 (i.e., is in a non-set state), a liquid discharge port 471a of the second liquid storage tank 47 is closed by a liquid supply valve 471 so that liquid L does not leak. As illustrated in part (C) of FIG. 13, when the second liquid storage tank 47 is set to the second-liquid-storage-tank fixer 61, the liquid supply valve 471 is pushed up to open the liquid discharge port 471a of the second liquid storage tank 47. Thus, the liquid L can flow out from the second liquid storage tank 47 to the second-liquid-storage-tank fixer 61. As a result, the liquid L stored in the second liquid storage tank 47 flows out to the second-liquid-storage-tank fixer 61. The liquid L that has flowed out from the second liquid storage tank 47 is stored in the second-liquid-storage-tank fixer 61.

As a measurement to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply passage 45 is supplied by the liquid supply pump 46 to the second-liquid-storage-tank fixer 61 via the liquid supply passage 45 in the reverse direction. For that purpose, the second-liquid-storage-tank fixer 61 is set to the capacity that can sufficiently store liquid L in the first liquid storage tank 44 and the liquid supply passage 45.

As illustrated in part (B) and part (C) of FIG. 13, the second-liquid-storage-tank fixer 61 is provided with a liquid drain plug 611. After the liquid L remaining in the first liquid storage tank 44 and the liquid supply passage 45 is reversely fed by the liquid supply pump 46 to the second-liquid-storage-tank fixer 61, the liquid drain plug 611 is opened to drain the liquid L stored in the second-liquid-storage-tank fixer 61 to the outside of the post-processing apparatus 3.

A description is given below of a binding process.

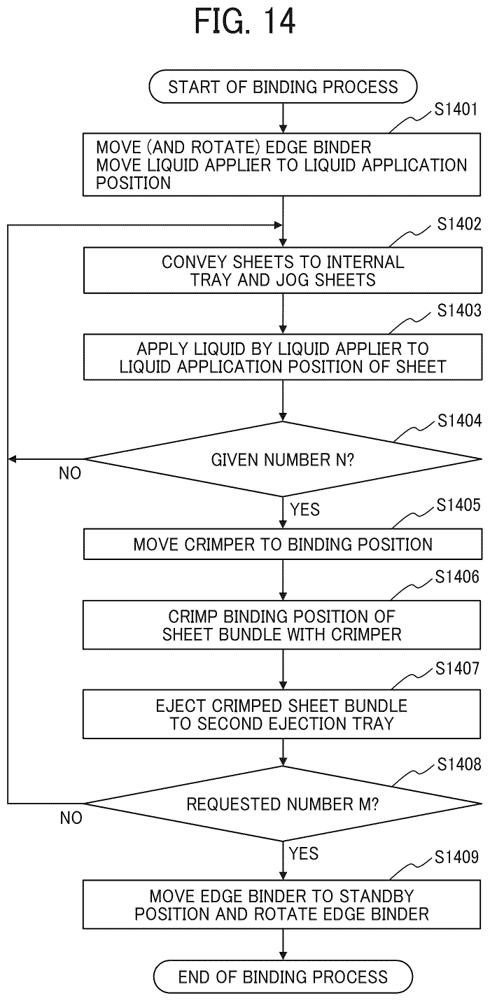

Specifically, a description is given below of a binding process executed by the edge binder 25 included in the post-processing apparatus 3. FIG. 14 is a flowchart of a process of executing one-point binding. FIGS. 15A, 15B, 15C, and 15D are diagrams illustrating the position shift of the edge binder 25 (including the liquid applier 31 and the crimper 32) during the one-point binding. FIGS. 15A, 15B, 15C, and 15D do not illustrate changes in the postures of the liquid applier 31 and the crimper 32. The position (liquid application position) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding process illustrated in FIG. 14 when the controller 100b acquires an execution command of the binding process from the image forming apparatus 2. In the following description, the execution command of the binding process may be referred to as a “binding command.”

The binding command includes, for example, the type of the sheet P (including information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.”

The liquid applier 31 and the crimper 32 are assumed to be in a parallel binding posture and located at a standby position HP (FIG. 15A) that is a position shifted in the width direction from the sheets P placed on the internal tray 22 at the start of the binding process.

When the posture that is instructed by the binding command is the oblique binding posture, in step S1401, the controller 100b drives the liquid-applier pivot motor 563 and the crimper pivot motor 56 to rotate the liquid applier 31 and the crimper 32 of the edge binder 25 into the oblique binding posture. When the posture that is instructed by the binding command is the “inclined binding posture,” the crimper 32 alone may be pivoted to the inclined binding posture and the liquid applier 31 may not be pivoted in both forward and reverse directions. Such a configuration can simplify the driving mechanism as compared with a configuration in which both the liquid applier 31 and the crimper 32 are rotated in both forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b skips the aforementioned operation of pivoting the liquid applier 31 and the crimper 32 of the edge binder 25 to the inclined binding posture.

In step S1401, the controller 100b drives the edge-binder movement motor 55 to move the edge binder 25 in the main scanning direction so that the liquid applier 31 faces the first liquid application position B1 instructed by the binding command. The controller 100b executes the operation of step S1401 before a first sheet P is conveyed to the internal tray 22 by the conveyance roller pairs 10, 11, 14, and 15.

In step S1402, the controller 100b rotates the conveyance roller pairs 10, 11, 14, and 15 to store the sheet P, on which the image has been formed by the image forming apparatus 2, onto the internal tray 22. In step S1402, the controller 100b also moves the side fences 24L and 24R in the main scanning direction to align the position of the sheet P or the sheet bundle Pb placed on the internal tray 22 in the main scanning direction. In short, the controller 100b performs so-called jogging.

In step S1403, the controller 100b causes the liquid applier 31 facing the first liquid application position B1 to apply liquid to the first liquid application position B1 of the sheet P placed on the internal tray 22 in the immediately preceding step S1402, based on the liquid application control data adjusted in advance. In other words, the controller 100b drives the liquid-applier movement motor 42 to bring the liquid application member 501 into contact with the first liquid application position B1 on the sheet P placed on the internal tray 22 (see FIG. 15B). In the liquid application in step S1403, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid-applier movement motor 42 based on the adjusted control data, and adjusts the amount of movement of the liquid application member 501 with respect to the first liquid application position B1 of the sheet P placed on the internal tray 22.

In step S1404, the controller 100b determines whether the number of sheets P placed on the internal tray 22 has reached the given number of sheets N instructed by the binding command. When the controller 100b determines that the number of sheets P placed on the internal tray 22 has not reached the given number of sheets N (NO in step S1404), the controller 100b executes the operations of steps S1402 to S1404 again until the number of sheets P placed on the internal tray 22 reaches the given number of sheets N (YES in step S1404). In other words, the controller 100b executes the processing of steps S1402 to S1404 each time the sheet P is conveyed to the internal tray 22 by the conveyance roller pairs 10, 11, 14, and 15. The liquid application by the liquid applier 31 may be performed not only on all of the plurality of sheets P included in the sheet bundle Pb but also on only some of the plurality of sheets P included in the sheet bundle Pb.

When the controller 100b determines that the number of sheets P placed on the internal tray 22 has reached the given number of sheets N (YES in step S1404), in step S1405, the controller 100b drives the edge-binder movement motor 55 to move the edge binder 25 in the main scanning direction such that the crimper 32 faces the first binding position B1 as illustrated in FIG. 15C.

In step S1406, the controller 100b causes the crimper 32 to crimp the sheet bundle Pb placed on the internal tray 22. In step S1407, the controller 100b causes the conveyance roller pair 15 to eject the sheet bundle Pb thus crimped and bound by the crimper 32 to the second ejection tray 26. Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is supported on the internal tray 22 has a crimping area (corresponding to the first binding position B1) sandwiched between the upper crimping teeth 32a and the lower crimping teeth 32b in step S1406. The crimping area overlaps with a liquid application area (corresponding to the first liquid application position B1) contacted by a distal end of the liquid application member 501 in step S1403. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlap with the liquid application area contacted by the distal end of the liquid application member 501, to obtain a sufficient binding strength.

In step S1408, the controller 100b determines whether the number of sheet bundles Pb thus ejected to the second ejection tray 26 has reached the requested number of copies M indicated by the binding command. When the controller 100b determines that the number of sheet bundles Pb thus ejected has not reached the requested number M of copies (NO in step S1408), the controller 100b executes the operations of step S1402 and subsequent steps again. In other words, when the controller 100b determines that the number of sheet bundles Pb thus ejected has not reached the requested number of copies M (NO in step S1408), the controller 100b repeats the operations of steps S1402 to S1408 until the number of sheet bundles Pb ejected to the second ejection tray 26 reaches the requested number of copies M.

On the other hand, when the controller 100b determines that the number of sheet bundles Pb output to the second ejection tray 26 has reached the requested number of copies M (YES in step S1408), in step S1409, the controller 100b drives the edge-binder movement motor 55 to move the edge binder 25 (the liquid applier 31 and the crimper 32) to the standby position HP as illustrated in FIG. 15D. When the posture that is instructed by the binding command is the “oblique binding posture,” in step S1409, the controller 100b drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 that includes the liquid applier 31 and the crimper 32 returns to the standby position HP position illustrated in FIG. 15D. In steps S1401 and S1409, the execution order of the movement in the main scanning direction and the rotation in the forward and reverse directions of the liquid applier 31 and the crimper 32 is not limited to the aforementioned order and may be reversed.

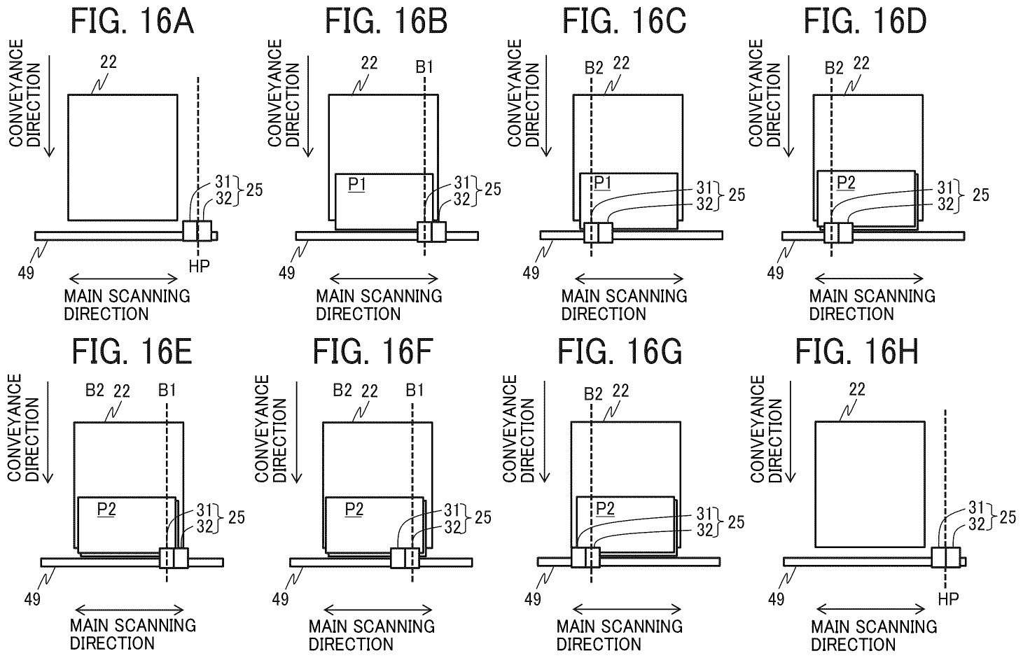

FIGS. 16A to 16H are diagrams illustrating the positions of the edge binder 25 during execution of two-point binding. A detailed description of points common to the process described with reference to FIGS. 15A to 15D may be omitted, and differences will be mainly described. As illustrated in FIG. 16A, it is assumed that the edge binder 25 is located at the standby position HP at the start point of the two-point binding. The first binding position B1 and the second binding position B2 are positions separated from each other in the main scanning direction. In FIGS. 16A to 16H, the case where two sheets P are crimped and bound (i.e., N=2) is illustrated. In the case of executing the two-point binding, the number of sheets P included in the sheet bundle Pb is not limited to two, and the two-point binding can be performed on a sheet bundle Pb having the same number of sheets as the number of sheets that can be bound in one-point binding.

Before a first sheet P1 for a sheet bundle Pb is supplied to the internal tray 22, the controller 100b moves the edge binder 25 in the main scanning direction such that the liquid applier 31 can face the first liquid application position B1 (see FIG. 16B). As illustrated in FIG. 16B, the liquid applier 31 is disposed at a position at which the liquid applier 31 can face the first crimp binding position B1. In such a state, the controller 100b causes the first sheet P1, on which an image has been formed by the image forming apparatus 2, to be placed on the internal tray 22 and performs a jogging process on the first sheet P1. In response to the placement of the first sheet P1 on the internal tray 22, the controller 100b causes the liquid applier 31 to apply the liquid to the first liquid application position B1 of the first sheet P1.

Subsequently, as illustrated in FIG. 16C, the controller 100b causes the edge binder 25 to move in the main scanning direction such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid to the first liquid application position B1 and the second liquid application position B2 of the first sheet P1, the controller 100b causes a second sheet P2 for the sheet bundle Pb to be placed on the internal tray 22 and performs the jogging process on the second sheet P2 in a state where the liquid applier 31 is disposed at a position which the liquid applier 31 can face the second liquid application position B2 as illustrated in FIG. 16D. In response to the placement of the second sheet P2 on the internal tray 22, the controller 100b causes the liquid applier 31 to apply the liquid to the second liquid application position B2 of the second sheet P2.

Then, as illustrated in FIG. 16E, the controller 100b causes the edge binder 25 to move in the main scanning direction such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeat the conveyance of the sheet P and the liquid application to the first liquid application position B1 and the second liquid application position B2 until the number of sheets P placed on the internal tray 22 reaches the given number of sheets N. At this time, the controller 100b causes the liquid applier 31 to apply the liquid to the B-th sheet P (B<N) in the order of the first liquid application position B1 and the second liquid application position B2. The controller 100b also causes the liquid applier 31 to apply the liquid to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, in response to a determination that the number of sheets P placed on the internal tray 22 has reached the given number of sheets N, the controller 100b causes the edge binder 25 to move in the main scanning direction such that the crimper 32 faces the first binding position B1 as illustrated in FIG. 16F. The controller 100b causes the crimper 32 to perform crimp binding on the first binding position B1 of the sheet bundle Pb placed on the internal tray 22.

Then, as illustrated in FIG. 16G, the controller 100b causes the edge binder 25 to move in the main scanning direction such that the crimper 32 faces the second binding position B2. The controller 100b causes the crimper 32 to perform crimp binding on the second binding position B2 of the sheet bundle Pb placed on the internal tray 22.

In the example illustrated in FIGS. 16A to 16H, the liquid is finally applied to the first binding position B1, and crimping is performed in the order of the first binding position B1 and the second binding position B2. On the other hand, when the liquid is finally applied to the second binding position B2, crimping is performed in the order of the second binding position B2 and the first binding position B1.

The controller 100b outputs the sheet bundle Pb crimped and bound at the first binding position B1 and the second binding position B2 to the second ejection tray 26. Further, as illustrated in FIG. 16H, the controller 100b causes the edge binder 25 to move to the standby position HP.

Although an example in which one or two positions of the sheet bundle Pb are crimped and bound has been described in the above-described embodiment, an embodiment of the present disclosure is also applicable to a case in which three or more positions of the sheet bundle Pb spaced apart from each other in the main scanning direction are crimped and bound. In such cases, the controller 100b causes the liquid applier 31 to apply the liquid to three or more liquid application positions (corresponding to the crimp binding positions) and causes the crimper 32 to perform crimping. According to an embodiment of the present disclosure, the productivity of crimping can be enhanced even when three or more positions are crimped and bound.

However, it is not necessary to apply the liquid to all the liquid application positions (corresponding to crimping positions) for all the sheets P included in the sheet bundle Pb. For example, when crimping is performed on three liquid application positions (corresponding to crimping positions) apart from each other in the main scanning direction, the controller 100b may cause the liquid applier 31 to apply the liquid to three liquid application positions (corresponding to crimping positions) of an E-th sheet P1 (E<N−2), apply the liquid to two liquid application positions (corresponding to crimping positions) of an (E+1)-th sheet P2, and apply the liquid to one liquid application position (corresponding to a crimping position) of an (E+2)-th sheet P2.

A description is given below of a first example of a liquid supply assembly for the liquid applier 31.

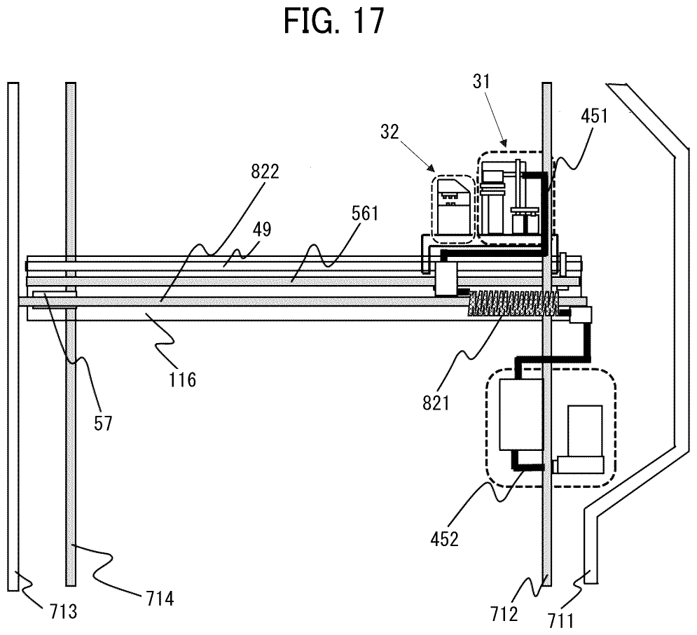

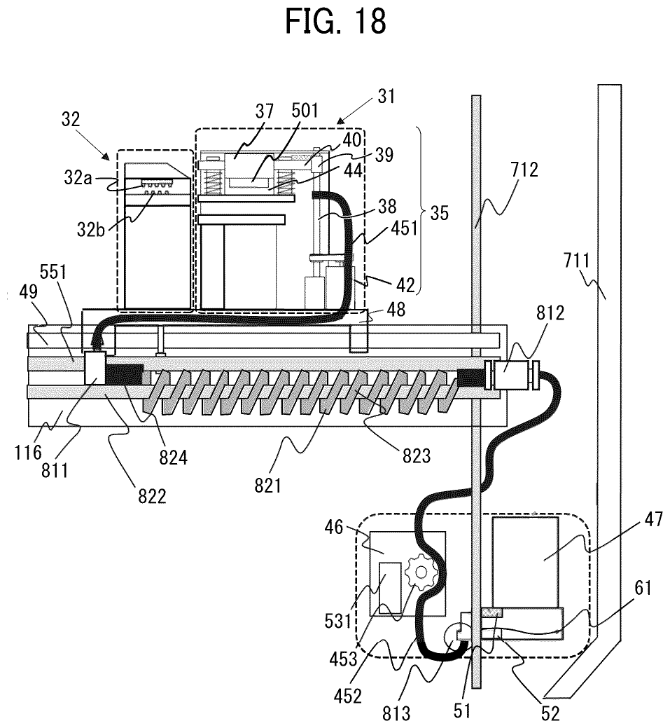

Specifically, a description is given of a first example of a liquid supply assembly for supplying the liquid for liquid application from the second liquid storage tank 47 to the first liquid storage tank 44 in the liquid applier 31. FIGS. 17 and 18 are diagrams illustrating the edge binder 25 illustrated in FIG. 2 and its surrounding structure. FIGS. 17 and 18 are diagrams illustrating the edge binder 25 viewed from the side on which the conveyance roller pair 15 illustrated in FIG. 2 is disposed, including the liquid supply assembly included in the edge binder 25.

FIG. 17 illustrates an example in which the edge binder 25 is positioned on one end when the edge binder 25 reciprocates along the width direction of the sheet P, which is the direction orthogonal to the conveyance direction of the sheet P. FIG. 18 illustrates an example in which the edge binder 25 is positioned on the other end when the edge binder 25 reciprocates along the width direction of the sheet P.

The liquid applier 31 is arranged side by side with the crimper 32, which is an example of a medium processing device. The liquid application member 501, which is an example of a liquid application unit, is connected to a liquid-applier movement motor 42, which is an example of a contact and separation device, via a base plate 40. The liquid application member 501 is movable up and down in the vertical direction.

The crimper 32 and the liquid applier 31 are fixed to the base 48 and movable along the guide shaft 49 by using the edge-binder movement assembly 57 and the driving force transmission assembly 551.

In the liquid applier 31, the first liquid storage tank 44 for storing the liquid for the liquid application is disposed near the liquid application member 501.

The second liquid storage tank 47 is provided outside such a unit including the liquid applier 31, for example, on the housing side plate 712, and is removable when the cover 711 is opened.

A description is given below of a configuration of feeding liquid from the second liquid storage tank 47 to the first liquid storage tank 44. When the cover 711 is opened and the second liquid storage tank 47 is set to the second-liquid-storage-tank fixer 61, the liquid stored in the second liquid storage tank 47 flows out to the second-liquid-storage-tank fixer 61. Thus, the second-liquid-storage-tank fixer 61 is filled with a certain amount of liquid. The second-liquid-storage-tank fixer 61 is provided with a second liquid-level sensor that detects that the liquid is equal to or less than a set amount. A third supply coupler 813 is disposed on the bottom of the second-liquid-storage-tank fixer 61. The third supply coupler 813 is a protrusion having a hollow cylindrical shape in cross section, and liquid passes through the inside of the third supply coupler 813.

The second liquid supply passage 452 is attached so as to cover the third supply coupler 813. The second liquid supply passage 452 has a hollow cylindrical shape in cross section and is made of a material through which fluid can be fed. The second-liquid-storage-tank fixer 61 and the third supply coupler 813 may be an integral component or separate components.

The second liquid supply passage 452 passes through the inside of the liquid supply pump 46 and is connected to a second supply coupler 812. The liquid supply pump 46 is a tube-type constant-rate liquid feed pump and is fixed to the housing side plate 712. When a pump motor 531 rotates, a shoe 453 contacting the second liquid supply passage 452 rotates and sequentially moves to positions where the second liquid supply passage 452 is compressed. This operation allows air or liquid flowing from the second-liquid-storage-tank fixer 61 into the second liquid supply passage 452 to be fed in the rotation direction of the shoe 453.

The rotational amount of the shoe 453 and the amount of liquid to be fed by the shoe 453 are constant in the tube-type constant-amount liquid feed pump. Thus, the tube-type constant-amount liquid feed pump can feed the constant amount of liquid, and no valve structure is needed. Although the tube-type constant-amount liquid feed pump is used in this example, the liquid feed pump is not limited to the tube-type and any other type such as a propeller pump, a screw pump, or a peristaltic pump as long as liquid can be fed.

A coil tube 821 is disposed between the second supply coupler 812 and a first supply coupler 811. The second liquid supply passage 452 connected to the second liquid storage tank 47 is coupled to the second supply coupler 812. One end of the first liquid supply passage 451 connected to the first liquid storage tank 44 is coupled to the first supply coupler 811. The coil tube 821 expands and contracts following the sliding direction of the liquid applier 31 The coil tube 821 corresponding to a spiral portion constituting part of a liquid supply unit and the configuration related to the coil tube 821 will be described later.

As illustrated in FIG. 18, when the liquid applier 31 is positioned on one end in the sliding direction, the coil tube 821 is contracted.

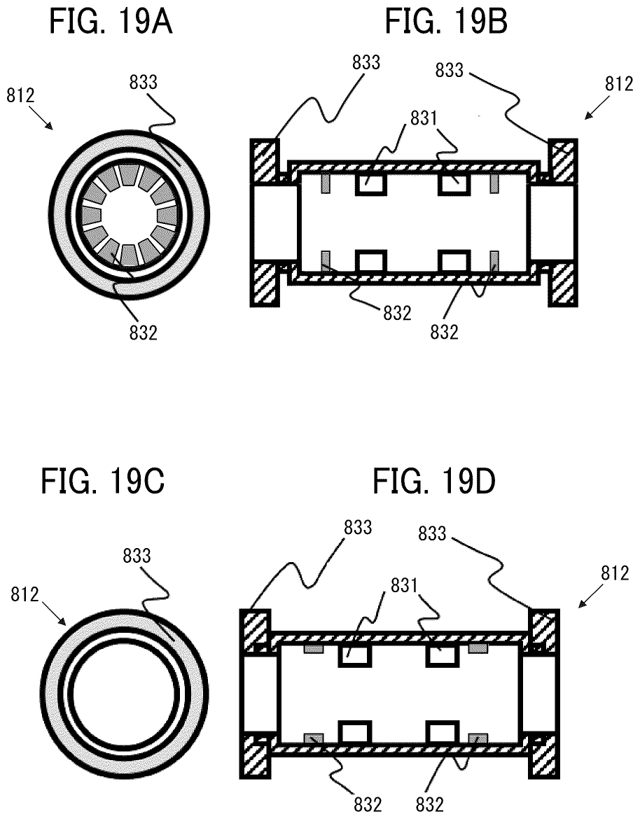

As illustrated in FIGS. 19A to 19D, which is a detailed view of the second supply coupler 812, hollow flow paths (the coil-tube straight portion 825 and the second liquid supply passage 452 as illustrated in FIG. 25) constituting the liquid supply passage 45 are attachable to both ends of the second supply coupler 812. The second supply coupler 812 includes elastic sleeves 831 that prevent leakage of liquid, lock claws 832 that prevent the liquid supply passage 45 from coming off, and release rings 833 that opens and closes the lock of the lock claws 832.

FIGS. 19A and 19B illustrate a state in which the liquid supply passage 45 is engaged and locked so as not to come off. FIG. 19A is a schematic view of the liquid supply passage 45 as viewed from the engagement direction, and FIG. 19B is a schematic view of the liquid supply passage 45 as viewed from a lateral side with respect to the engagement direction. FIGS. 19C and 19D illustrate a state of the liquid supply passage 45 when the liquid supply passage 45 is attached or detached.

As illustrated in FIGS. 19B and 19C, when the lock claws 832 are locked, the lock claws 832 stand vertically with respect to the wall surface, thus preventing the liquid supply passage 45 from coming off. When the liquid supply passage 45 is attached or detached, the release rings 833 are pushed in and the lock claws 832 are brought down along the wall surface as illustrated in FIGS. 19C and 19D, thus allowing the liquid supply passage 45 to be inserted or removed.

As illustrated in, e.g., FIG. 17, the coil tube 821 is coupled to one end of the second supply coupler 812. The coil tube 821 is wound around a coil tube shaft 822 and coupled to the first supply coupler 811.

The first liquid supply passage 451 coupled to one end of the first supply coupler 811 corresponding to a linear portion constituting part of the liquid supply unit passes, e.g., the lower side of the base 48, and is coupled to the first liquid storage tank 44 from the front side of the post-processing apparatus 3 with respect to the liquid applier 31. Accordingly, air or liquid is fed along the path from the second liquid storage tank 47 to the first liquid storage tank 44, thus allowing liquid to be fed to the first liquid storage tank 44. In this example, a silicon tube or a joint is assumed as a member constituting the liquid supply passage 45. However, the material and the connection method are not limited to those in this example and may be any other material and connection method as long as liquid can be sent without leaking. For example, a connection method built in each component may be used.

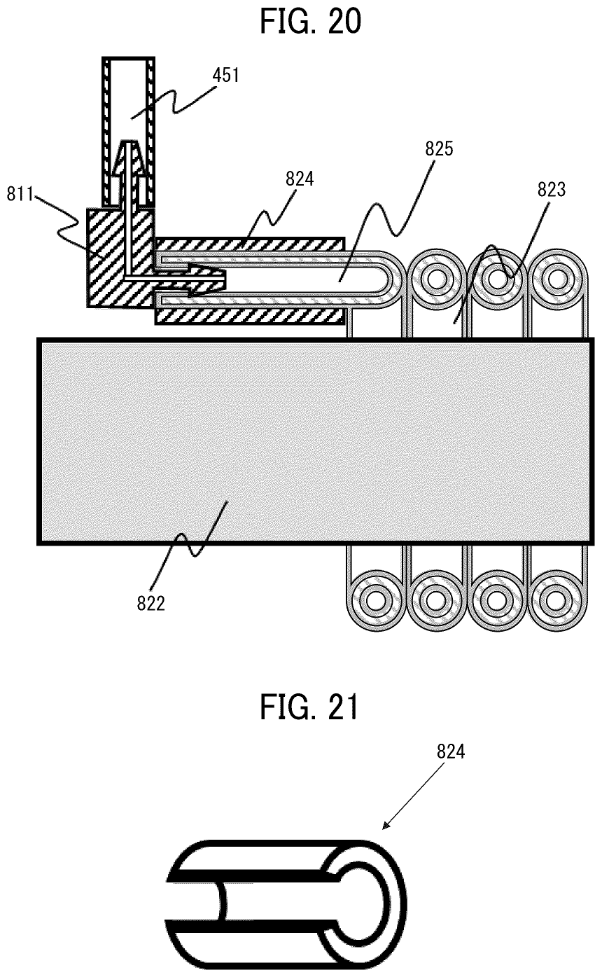

FIG. 20 is a sectional view of a configuration in which a second supply protector 824 is attached between the coil tube 821 and the first supply coupler 811. The first supply coupler 811 has cylindrical protrusions of an arrow-shape in cross section. A coil-tube straight portion 825 and one end of the first liquid supply passage 451 can be attached so as to cover the protrusions. When the coil-tube straight portion 825 and one end of the first liquid supply passage 451 are engaged with the first supply coupler 811, the inside of the coil-tube straight portion 825 and the first liquid supply passage 451 turns into a state where liquid can flow, thus allowing liquid feeding.

FIG. 21 is a three-dimensional view of the second supply protector 824. The second supply protector 824 made of a non-stretchable material is a member that covers the periphery of the coil-tube straight portion 825, which is a linear portion. The second supply protector 824 is a hollow cylindrical member that is not bent, and is made of, for example, a resin such as polyethylene or a metal such as stainless steel. When the second supply protector 824 is used, the portion that expands and contracts due to the reciprocating movement of the liquid applier 31 can be limited to only the coil-tube spiral portion 823, which is a spiral portion that can expand and contract.

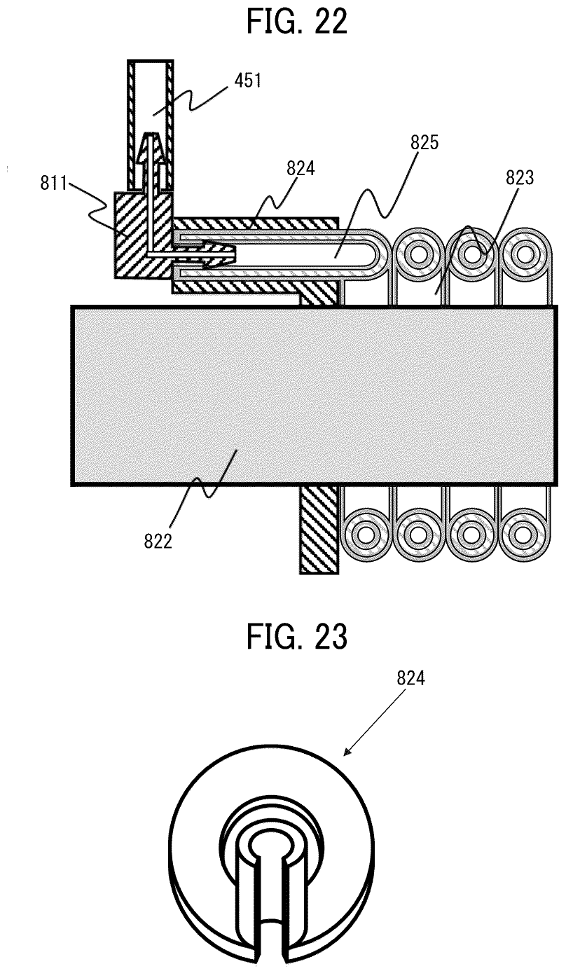

FIG. 22 is a sectional view of a configuration in which the second supply protector 824 presses the entire end face of the coil-tube spiral portion 823 during contraction. FIG. 23 is a three-dimensional view of the second supply protector 824. When the second supply protector 824 is attached to the coil tube shaft 822 so that the second supply protector 824 is slidable, the force applied at the time of contraction can be uniformly applied to the end face of the coil-tube spiral portion 823.

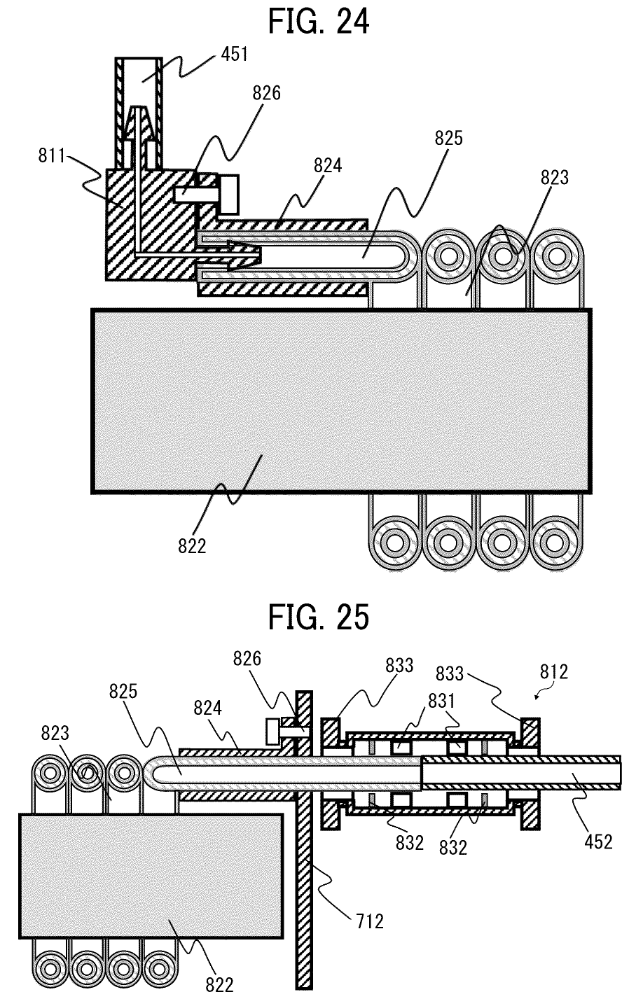

FIG. 24 illustrates a configuration in which the second supply protector 824 is attached to the crimper 32 or the liquid applier 31. When the coil-tube straight portion 825 is fastened to a component that reciprocates in the post-processing apparatus 3 using a second supply fastener 826, the coil-tube straight portion 825 can be prevented from being bent.

FIG. 25 illustrates a configuration in which the second supply fastener 826 is fixed to a place such as the binding assembly base 116 or the housing side plate 712, which is not moved by the reciprocating movement of the liquid applier 31, using the second supply fastener 826. When the coil-tube straight portion 825 is fastened to a component that does not reciprocate in the post-processing apparatus 3 using the second supply fastener 826, the coil-tube straight portion 825 can be prevented from being bent.

In the above description, the controller 100b of the post-processing apparatus 3 is provided separately from the controller 100a of the image forming apparatus 2 as illustrated in FIG. 1. However, the present disclosure is not limited to the above-described configuration.

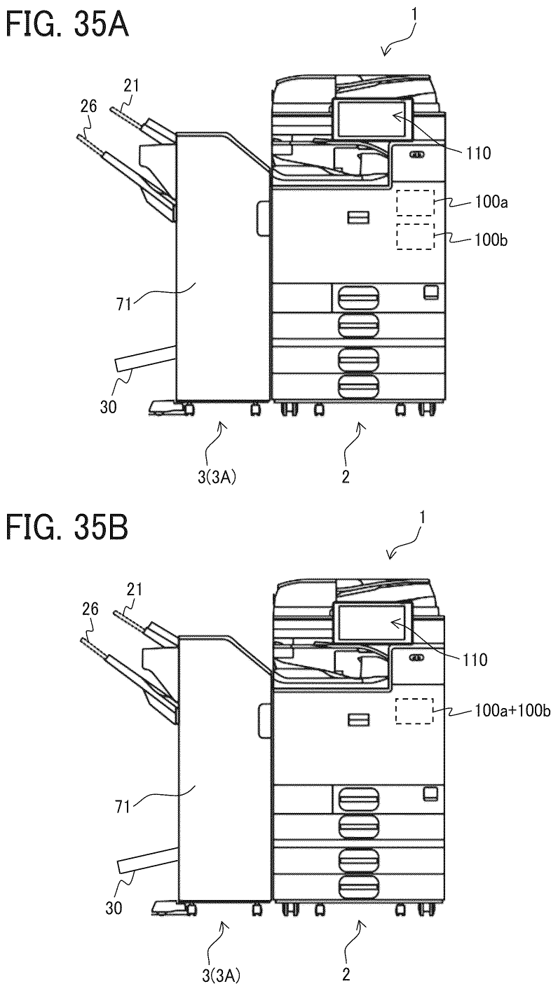

For example, as illustrated in FIG. 35A, the controller 100b of the post-processing apparatus 3 may be disposed in the image forming apparatus 2. Further, as illustrated in FIG. 35B, the controller 100b of the post-processing apparatus 3 may be integrated with the controller 100a of the image forming apparatus 2.

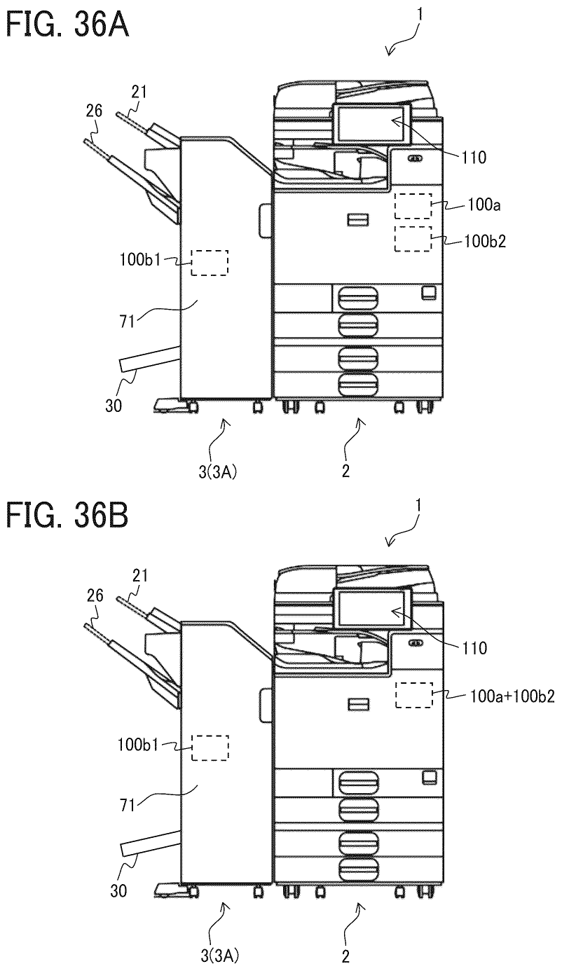

As illustrated in FIG. 36A, the controller 100b of the post-processing apparatus 3 may be divided into a controller 100b1 (e.g., a driver system such as a motor) and a controller 100b2 (a detector system such as a sensor) according to the functions, and only the controller 100b2 of the post-processing apparatus 3 may be disposed in the image forming apparatus 2. Further, as illustrated in FIG. 36B, the controller 100b2 of the post-processing apparatus 3 disposed in the image forming apparatus 2 may be integrated with the controller 100a of the image forming apparatus 2.

A description is given below of a post-processing apparatus 3A according to a second embodiment.

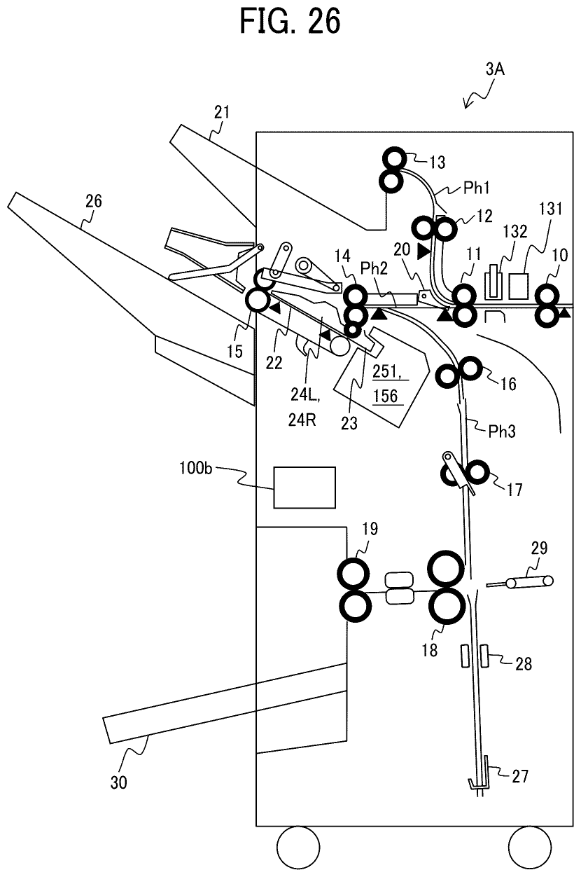

The post-processing apparatus 3A according to the second embodiment is described with reference to FIGS. 26 to 34. Components common to those of the post-processing apparatus 3 according to the first embodiment are attached with the same or like reference signs, and detailed descriptions may be omitted.

An edge binder 251 of the post-processing apparatus 3A according to the second embodiment is different from the edge binder 25 of the post-processing apparatus 3 according to the first embodiment in which the liquid applier 31 and the crimper 32 are arranged side by side, in that the edge binder 251 includes a crimper 32′ only and a liquid applier 131 is disposed on the upstream side in a conveyance passage. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as a “reverse conveyance direction” in the following description. A direction that is orthogonal to both the opposite conveyance direction and the thickness direction of the sheet P is defined as the “main scanning direction” or the “width direction of the sheet P.”

The liquid application position to which the liquid is applied on the sheet P or the sheet bundle Pb by the liquid applier 131 corresponds to the binding position on the sheet bundle Pb to be crimped and bound by the crimper 32′. For this reason, in the following description, the liquid application position and the binding position are described with the same reference sign B1.

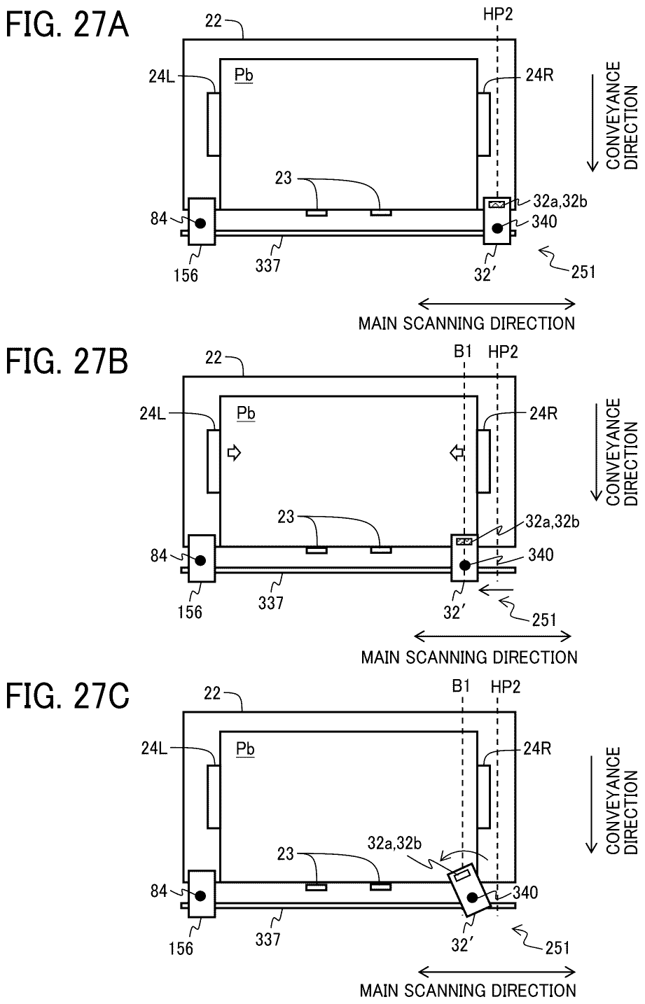

FIG. 26 is a diagram illustrating an internal configuration of the post-processing apparatus 3A according to the second embodiment. As illustrated in FIGS. 27A, 27B, and 27C, the edge binder 251 includes the crimper 32′. As illustrated in FIGS. 27A, 27B, and 27C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper rotation shaft 340 and a stapler shaft 84 both extending in the thickness direction of the sheet bundle Pb placed on the internal tray 22. In other words, the crimper 32′ and the staple binder 156 bind, at any desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22, thus allowing the sheet bundle Pb to be stapled.

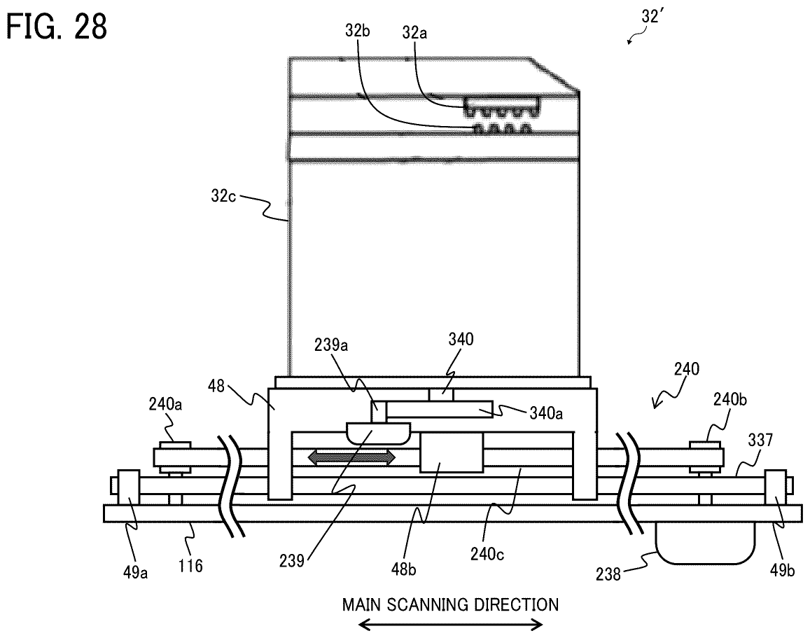

FIGS. 27A, 27B, and 27C are schematic views of the internal tray 22 as viewed from the thickness direction of the sheet bundle Pb. FIG. 28 is a schematic view of the crimper 32′ as viewed from the downstream side in the conveyance direction. As illustrated in FIGS. 27A, 27B, and 27C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper rotation shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in the thickness direction of the sheet bundle Pb. Since the other components of the staple binder 156 are similar to those of the staple binder 155 (see FIG. 9) of the post-processing apparatus 3 according to the first embodiment, a detailed description thereof is omitted.

As illustrated in FIG. 28, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimping frame 32c has a fastening portion 48b for a timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper rotation shaft 340 including a drive transmission gear 340a is fixed to a bottom face of the crimping frame 32c that holds the components of the crimper 32′.

The crimper rotation shaft 340 and the drive transmission gear 340a are held by a base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper rotation shaft 340 via the output gear 239a and the drive transmission gear 340a, the crimper 32′ rotates in the forward and reverse directions on the base 48 about the crimper rotation shaft 340 extending in the thickness direction of the sheet P placed on the internal tray 22. The guide rail 337, the crimper movement motor 238, the crimper pivot motor 239, the crimper rotation shaft 340, and the drive transmission assembly 240 constitute at least part of an example of a driving assembly of the crimper 32′.

The crimper 32′ is movable between a standby position HP2 illustrated in FIG. 27A and a position where the crimper 32′ faces the first binding position B1 illustrated in FIGS. 27B and 27C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the example of FIGS. 27A, 27B, and 27C, and the first binding position B1 may be any one or more positions in the main scanning direction in a downstream end in the conveyance direction of the sheet P.

The posture of the crimper 32′ changes or is pivoted between a parallel binding posture illustrated in 27B and an oblique binding posture illustrated in FIG. 27C. In other words, the crimper 32′ is rotatable in the forward and reverse directions about the crimper rotation shaft 340. The parallel binding posture is a posture of the crimper 32′ in which the length of the upper crimping teeth 32a and the lower crimping teeth 32b (i.e., a rectangular crimping trace) is along the main scanning direction. The oblique binding posture is a posture of the crimper 32′ in which the length of the upper crimping teeth 32a and the lower crimping teeth 32b (i.e., the rectangular crimping trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 27C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the reverse conveyance direction. In addition, the liquid applier 131 and the hole punch 132 are disposed at different positions in the reverse conveyance direction to simultaneously face one sheet P that is conveyed by the conveyance roller pairs 10 to 19.

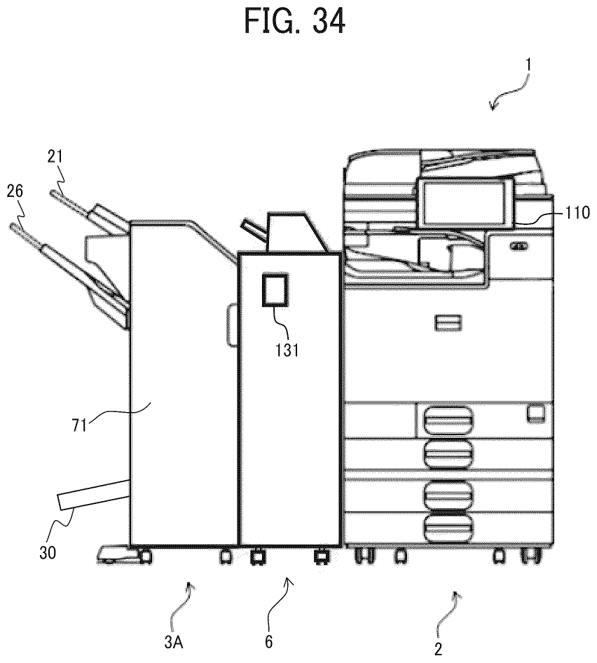

The liquid applier 131 and the hole punch 132 according to the present embodiment are disposed between the conveyance roller pairs 10 and 11. However, the arrangement of the liquid applier 131 is not limited to the example of FIG. 26. For example, in a case where an inserter 6 is disposed between the image forming apparatus 2 and the post-processing apparatus 3A as illustrated in FIG. 34, the liquid applier 131 may be disposed inside the inserter 6 located upstream from the post-processing apparatus 3A in a direction in which the sheet P is conveyed from the image forming apparatus 2 to the post-processing apparatus 3A. An example of the inserter 6 is an apparatus that allows a pre-printed medium, which is conveyed to the post-processing apparatus 3A together with the sheet P conveyed from the image forming apparatus 2, to be fed as a cover sheet, an insertion sheet, or a partition sheet without passing through the image forming apparatus 2.

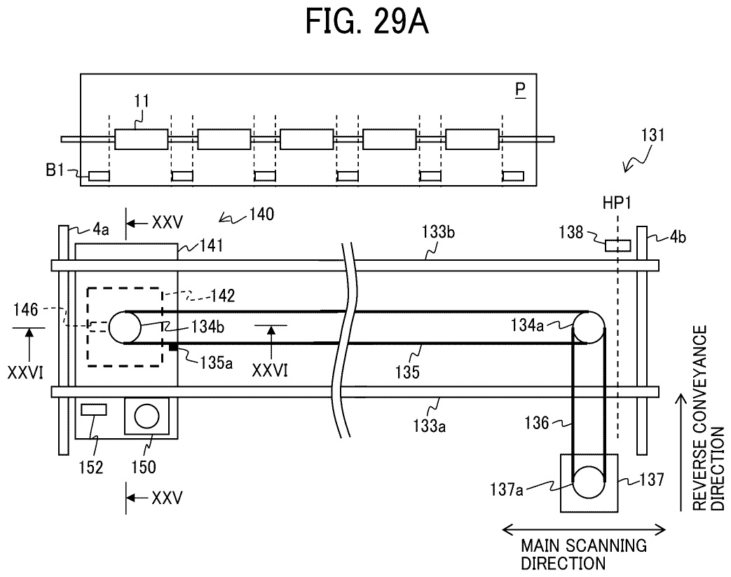

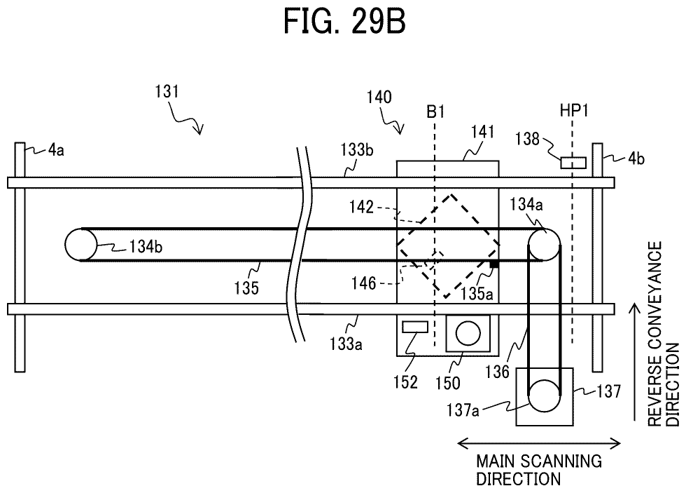

As illustrated in FIG. 29A, the conveyance roller pair 11 is located so as not to overlap, in the main scanning direction, the first liquid application position B1 on the sheet P to which the liquid is applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, a plurality of paired rollers included in the conveyance roller pair 11 are located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs included in the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

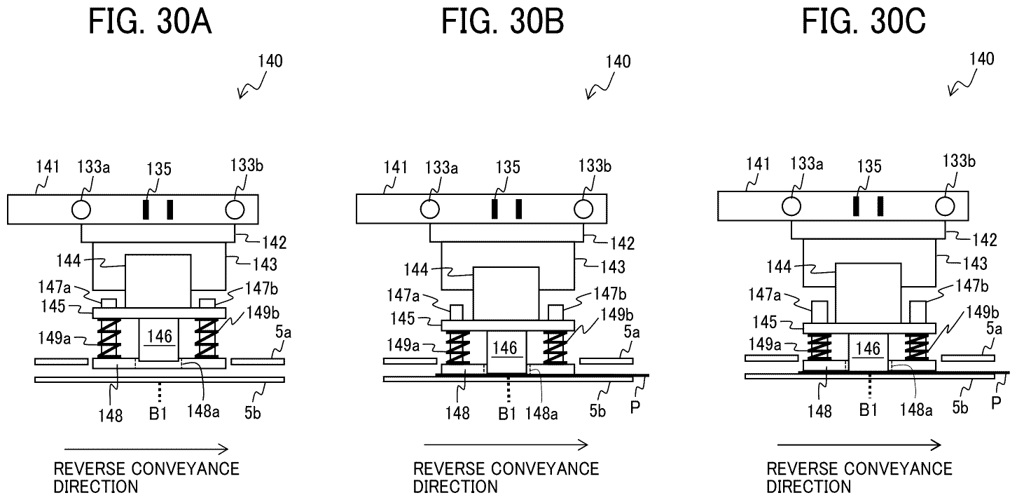

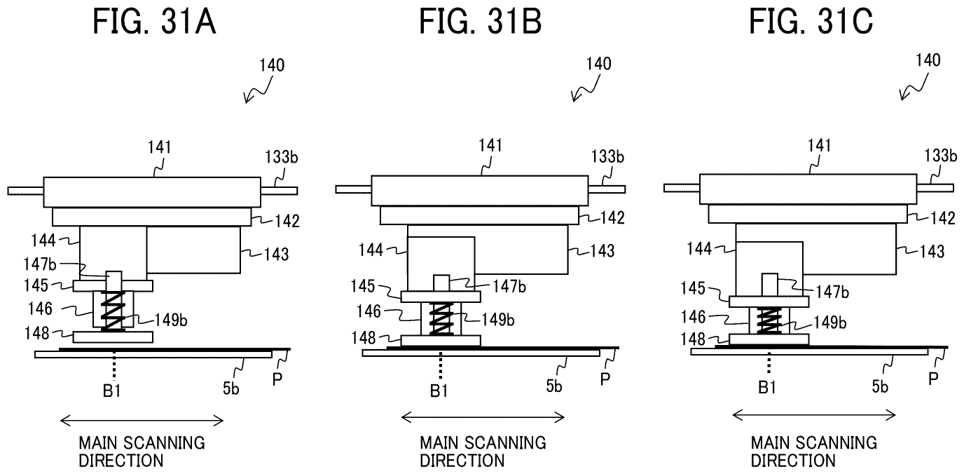

FIGS. 29A and 29B are views of the liquid applier 131 in the thickness direction of the sheet P, according to the second embodiment. FIGS. 30A, 30B, and 30C are sectional views of the liquid applier 131 taken along line XXV-XXV of FIG. 29A. FIGS. 31A, 31B, and 31C are sectional views of the liquid applier 131 taken along line XXVI-XXVI of FIG. 29A. As illustrated in FIGS. 29A to 31C, the liquid applier 131 includes a pair of guide shafts 133a and 133b, a pair of pulleys 134a and 134b, endless annular belts 135 and 136, a liquid-applier movement motor 137, a standby position sensor 138, and the liquid application unit 140.

The pair of guide shafts 133a and 133b each extend in the main scanning direction at positions spaced apart from each other in the reverse conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the reverse conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is entrained around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid-applier movement motor 137 being switched.

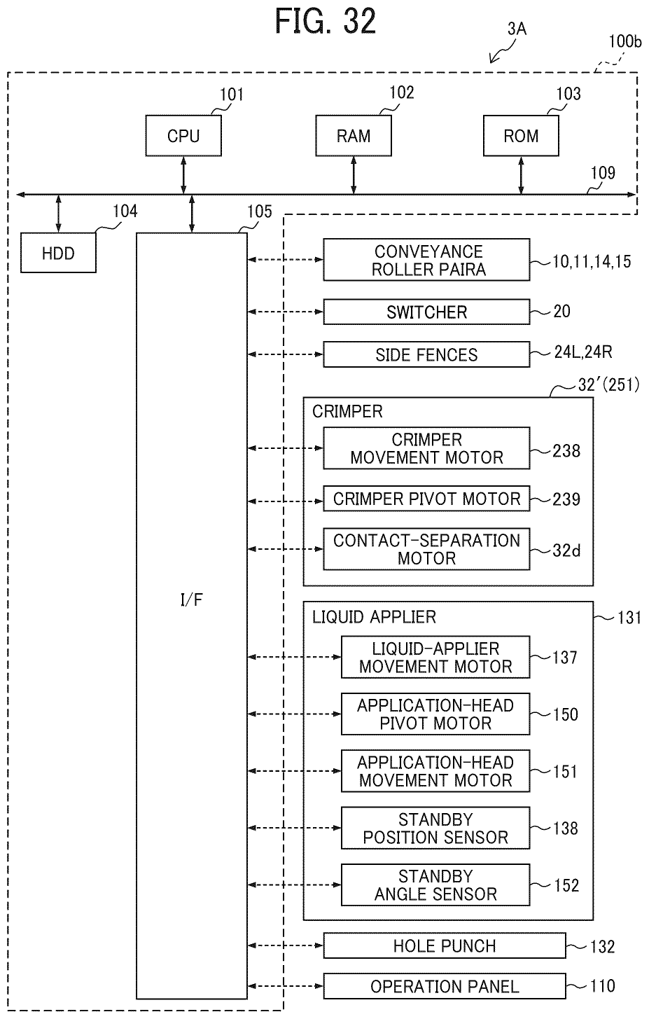

The standby position sensor 138 detects that the liquid application unit 140 has reached a standby position HP1 (see FIGS. 29A and 29B) in the main scanning direction. The standby position sensor 138 then outputs a standby position signal indicating the detection result to the controller 100b, which will be described below with reference to FIG. 32. The standby position sensor 138 is, for example, an optical sensor including a light emitter and a light receiver. The liquid application unit 140 at the standby position blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 30A, 30B, and 30C, the conveyance passage inside the post-processing apparatus 3A is defined by an upper guide plate 5a and a lower guide plate 5b, which are spaced apart from each other in the thickness direction of the sheet P. The liquid application unit 140 is located at a position to face an opening of the upper guide plate 5a. In other words, the liquid application unit 140 is disposed to face the conveyance passage (a position at which the liquid application unit 140 can face the sheet P) through the opening of the upper guide plate 5a.

As illustrated in FIGS. 29A to 31C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 32), and a standby angle sensor 152 (see FIG. 32).

The base 141 is supported by the pair of guide shafts 133a and 133b so as to be slidable in the main scanning direction. The base 141 is coupled to the endless annular belt 135 by the connection 135a. The base 141 supports the components 142 to 152 of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 32, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. However, the specific configuration of the standby angle sensor 152 is not limited to the above-described example.

FIG. 29A illustrates the rotary bracket 142 in a position for the parallel binding that is performed by the crimper 32′ disposed downstream from the liquid applier 131 in a direction in which the sheet P is conveyed. FIG. 29B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves with respect to the liquid storage tank 143 by a driving force transmitted from the application-head movement motor 151. The holder 145 is attached to a lower end of the liquid-application-head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b are movable with respect to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 in a direction away from the holder 145.

As illustrated in FIGS. 30A and 31A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b move down together, and the pressure plate 148 contacts the sheet P. The first liquid application position B1 is a position (i.e., the first binding position B1) to be crimped and bound by the edge binder 251 (i.e., the crimper 32′).

As the application-head movement motor 151 keeps rotating in the first direction even after the pressure plate 148 contacts the sheet P, the coil springs 149a and 149b are compressed to further move down the liquid-application-head mover 144, the holder 145, the liquid application head 146, and the columns 147a and 147b. As a result, as illustrated in FIGS. 30B and 31B, a lower face of the liquid application head 146 contacts the sheet P through the through hole 148a. As a result, the liquid contained in the liquid application head 146 is applied to the sheet P.

Further rotation of the application-head movement motor 151 in the first direction further strongly presses the liquid application head 146 against the sheet P as illustrated in FIGS. 30C and 31C. Accordingly, the amount of liquid applied to the sheet P increases. In short, the liquid applier 131 changes the pressing force of the liquid application head 146 against the sheet P to adjust the amount of liquid that is applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIGS. 30A and 31A, the liquid application head 146 and the pressure plate 148 are separated from the sheet P. In other words, the liquid applier 131 includes the liquid application head 146 that can be separated from the sheet P.

FIG. 32 is a block diagram illustrating a hardware configuration of control blocks that control the operation of the post-processing apparatus 3A according to the second embodiment. As illustrated in FIG. 32, the post-processing apparatus 3A has a configuration in which a central processing unit (CPU) 101, a random-access memory (RAM) 102, a read-only memory (ROM) 103, a hard disk drive (HDD) 104, and an interface (I/F) 105 are connected via a common bus 109.

The CPU 101 is an arithmetic device and controls the overall operation of the post-processing apparatus 3A. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3A processes, by an arithmetic function of the CPU 101, e.g., a control program stored in the ROM 103 and an information processing program (or application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the I/F 105 constitute at least part of the controller 100b, which is an example of a control device, to control the operation of the post-processing apparatus 3A.

The I/F 105 is an interface that connects the conveyance roller pairs 10, 11, 14, and 15, the switcher 20, the side fences 24L and 24R, the crimper movement motor 238, the crimper pivot motor 239, a contact-separation motor 32d, a liquid-applier movement motor 137, an application-head pivot motor 150, an application-head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switcher 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132. The controller 100b acquires detection results from the standby position sensor 138 and the standby angle sensor 152 through the I/F 105.

Although FIG. 32 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 34, the image forming apparatus 2 includes the operation panel 110. The operation panel 110 includes an operation section that receives instructions input by an operator and a display (which is an example of a notifier) that notifies the operator of information. The operation device includes, for example, hard keys and a touch screen overlaid on the display. The operation panel 110 acquires information from the user through the operation section and provides information to the user through the display. The post-processing apparatus 3A may include an operation panel 110 similar to the above-described operation panel 110.

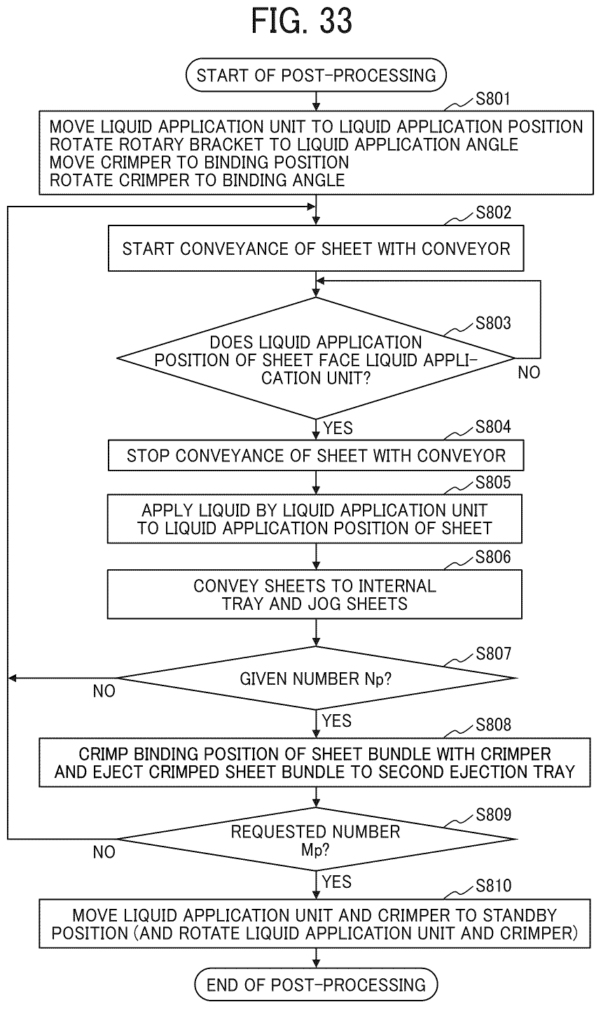

FIG. 33 is a flowchart of post-processing of the post-processing apparatus 3A according to the second embodiment. Specifically, FIG. 33 is a flowchart of a process in executing the one-point binding illustrated in FIGS. 27A to 27C.

For example, the controller 100b executes the post-processing illustrated in FIG. 33 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of sheets Mp”), the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (punching a hole in the present embodiment). At the start of the post-processing, the liquid application unit 140 is at the standby position HP1 illustrated in FIGS. 29A and 29B, and the rotary bracket 142 is held at the standby angle (corresponding to the parallel binding posture) at the standby position HP1.

First, the controller 100b drives the liquid-applier movement motor 137 to move the liquid application unit 140 (corresponding to a liquid application device) in the main scanning direction, thus causing the liquid application head 146 to move from the standby position HP1 to the position where the liquid application head 146 can face the first liquid application position B1 (see FIG. 29B, the position corresponding to the first binding position B1 illustrated in FIG. 27B and FIG. 30C). If the type of the binding process instructed by the post-processing command is “oblique binding process,” in step S801, the controller 100b drives the application-head pivot motor 150 to rotate the rotary bracket 142. Thus, the liquid application head 146 is rotated from the standby angle to the liquid application angle corresponding to the “oblique binding posture.” It can be ascertained, based on pulse signals output from rotary encoders of the liquid-applier movement motor 137 and the application-head pivot motor 150, that the liquid application head 146 has reached the position where the liquid application head 146 can face the first liquid application position B1. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, in step S801, the controller 100b drives the crimper movement motor 238 to move the crimper 32′ from the standby position HP2 to the position where the crimper 32′ can face the first binding position B1 as illustrated in FIGS. 27A and 27B. Alternatively, if the type of the binding process instructed by the post-processing command is “oblique binding process,” in step S801, the controller 100b drives the crimper pivot motor 239 to rotate the crimper 32′ from the standby angle to the crimping angle corresponding to the “oblique binding posture.” It is ascertained based on a pulse signal output from a rotary encoder of the crimper movement motor 238 that the crimper 32′ has reached the position where the crimper 32′ can face the first binding position B1. Similarly, it is ascertained based on a pulse signal output from a rotary encoder of the crimper pivot motor 239 that the crimper 32′ has reached the crimping angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

In step S802, the controller 100b drives the conveyance roller pairs 10 and 11 to start conveying the sheet P on which an image is formed by the image forming apparatus 2. In step S803, the controller 100b determines whether the first liquid application position B1 on the sheet P has faced the liquid application unit 140 (more specifically, the liquid application head 146). When the controller 100b determines that the first liquid application position B1 on the sheet P has not faced the liquid application unit 140 (NO in S803), the controller 100b continues causing the conveyance roller pairs 10 and 11 to convey the sheet P until the first liquid application position B1 on the sheet P faces the liquid application unit 140 (YES in S803). When the controller 100b determines that the first liquid application position B1 on the sheet P has faced the liquid application head 146 (YES in step S803), in step S804, the controller 100b causes the conveyance roller pairs 10 and 11 to stop conveying the sheet P. It can be ascertained, based on a pulse signal output from a rotary encoder of a motor that drives the conveyance roller pairs 10 and 11, that the first liquid application position B1 on the sheet P has faced the liquid application head 146.

In step S805, the controller 100b causes the liquid application unit 140 to execute the process of applying liquid to the first liquid application position B1 on the sheet P. More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. In step S806, the controller 100b also moves the side fences 24L and 24R to align the position of the sheet P or the sheet bundle Pb placed on the internal tray 22 in the main scanning direction in step S806. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), in step S808, the controller 100b causes the crimper 32′ to crimp the binding position B1 (corresponding to the first liquid application position B1 of the sheet P) on the sheet bundle Pb including the sheet P to which the liquid has been applied by the liquid application unit 140. In step S808, the controller 100b also rotates the conveyance roller pair 15 to eject the crimped sheet bundle Pb to the second ejection tray 26.

In step S809, the controller 100b determines whether the number of sheet bundles Pb thus ejected to the second ejection tray 26 has reached the requested number of copies Mp indicated by the post-processing command. When the controller 100b determines that the number of the sheet bundles Pb ejected to the second ejection tray 26 has not reached the requested number of copies Mp (NO in step S809), the controller 100b repeats the processing of steps S802 to S809 until the number of the sheet bundles Pb ejected to the second ejection tray 26 reaches the requested number of copies Mp (YES in step S809).

When the controller 100b determines that the number of sheet bundles Pb ejected to the second ejection tray 26 reaches the requested number of copies Mp (YES in step S809), in step S810, the controller 100b drives the liquid-applier movement motor 137 to move the liquid application unit 140 to the standby position HP1 (see FIG. 29B) and drives the crimper movement motor 238 to move the crimper 32′ to the standby position HP2 (see FIGS. 27A).

When the posture that is instructed by the post-processing operation is the “oblique binding posture,” in step S810, the controller 100b drives the application-head pivot motor 150 and the crimper pivot motor 239 to rotate the liquid application unit 140 and crimper 32′ and the parallel binding posture (standby angle) into the parallel binding posture. By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S801 and S810, the execution order of the movement in the main scanning direction and the rotation in the forward and reverse directions of the liquid application unit 140 and the crimper 32′ is not limited to the aforementioned order and may be reversed.

The present disclosure can be applied to not only the edge binder 25 that executes edge binding but also to the saddle binder 28 that executes saddle stitching.

The configuration in which the controller 100b of the post-processing apparatus 3A according to the second embodiment illustrated in FIG. 26 is provided separately from the controller 100a of the image forming apparatus 2 similarly with FIG. 1 has been described, but it is not limited to such a configuration. For example, as illustrated in FIG. 35A, the controller 100b of the post-processing apparatus 3A may be disposed in the image forming apparatus 2. Further, as in the configuration of FIG. 35B, the controller 100b of the post-processing apparatus 3A may be integrated with the controller 100a of the image forming apparatus 2.

Similarly with FIG. 36A, the controller 100b of the post-processing apparatus 3A may be divided into a controller 100b1 (e.g., a driver system (such as a motor)) and a controller 100b2 (a detector system (such as a sensor)) according to the function, and the controller 100b2 of the post-processing apparatus 3A may be disposed in the image forming apparatus 2. Further, as in the configuration of FIG. 36B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

In the related art, some medium processing apparatuses include a function to apply liquid to a part of a sheet bundle to be pressed and deformed in the crimping process in order to enhance the binding strength.

In order to apply liquid to sheets as sheet-shaped media when performing crimping, a liquid reserve tank and an expansion tank may be disposed in a binding unit that moves back and forth (reciprocates), and a user can remove the expansion tank from the binding unit and supply liquid.

For example, a first liquid storage unit mounted on a liquid application unit for applying liquid to a medium and a second liquid storage unit serving as a liquid supplier for replenishing the first liquid storage unit with liquid are linked by a supply tube. In such a configuration, preferably, the supply tube follows as a liquid application unit moves without hindering the flow of the liquid.

However, the supply tube may be bent due to expansion and contraction of the bellows portion when the liquid application unit is reciprocated in the width direction of a medium. As a result, the sectional area of the flow path of liquid through the supply tube is narrowed and the flow of the liquid may be hampered.

As described above, according to the preset embodiment, a reduction in the sectional area of a flow path due to movement of such a liquid application unit can be prevented, and the fluidity of liquid can be maintained.

The present disclosure is not limited to the above-described embodiments, and numerous additional modifications and variations are possible in light of the teachings within the technical scope of the appended claims. The above-described embodiments and modifications are some examples, and various modifications and variations can be practiced from such examples by those skilled in the art. Such modifications are included in the technical scope described in the scope of claims.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

### First Aspect

A medium processing apparatus includes a liquid applier to perform liquid application to at least one medium, a medium processing device to perform predetermined processing on a medium bundle including the at least one medium on which the liquid application has been performed by the liquid applier, a liquid storage to store the liquid used for the liquid application, a liquid application mover to enable the liquid applier to reciprocate along a direction orthogonal to a conveyance direction of the medium to the liquid applier, and a liquid supplier including a liquid supply unit to supply the liquid from the liquid storage to the liquid applier. The liquid supply unit includes a spiral portion to expand and contract to follow movement of the liquid applier and a linear portion to engage with the spiral portion with another member. The linear portion is covered with a non-stretchable protector.

### Second Aspect

In the medium processing apparatus according to the first aspect, the protector abuts against an entire end face of the spiral portion in a movement direction of the liquid applier.

### Third Aspect

In the medium processing apparatus according to the first or second aspect, the protector is attached to a position at which the protector moves together with the liquid applier.

### Fourth Aspect

In the medium processing apparatus according to the first or second aspect, the protector is attached to a position at which the protector does not move together with the liquid applier.

### Fifth Aspect

An image forming system includes: an image forming apparatus to form an image on a medium; and the medium processing apparatus according to any one of the first to fourth aspects to perform the predetermined processing on a plurality of media including the medium on which the image is formed by the image forming apparatus.

1. A medium processing apparatus, comprising:
a liquid applier to perform liquid application to a medium;
a medium processing device to perform processing on a medium bundle including the medium on which the liquid application has been performed by the liquid applier;
a liquid storage to store the liquid used for the liquid application;
a liquid application mover to enable the liquid applier to reciprocate along a direction orthogonal to a conveyance direction of the medium to the liquid applier; and
a liquid supplier including a liquid supply unit to supply the liquid from the liquid storage to the liquid applier,
the liquid supply unit including:
a spiral portion to expand and contract to follow movement of the liquid applier; and
a linear portion to engage with the spiral portion with another member, the linear portion being covered with a non-stretchable protector.

2. The medium processing apparatus according to claim 1,
wherein the protector abuts against an entire end face of the spiral portion in a movement direction of the liquid applier.

3. The medium processing apparatus according to claim 1,
wherein the protector is attached to a position at which the protector moves together with the liquid applier.

4. The medium processing apparatus according to claim 1,
wherein the protector is attached to a position at which the protector does not move together with the liquid applier.

5. An image forming system, comprising:
an image forming apparatus to form an image on media; and
the medium processing apparatus according to claim 1 to perform the processing on the medium bundle including the media on which the image is formed by the image forming apparatus.
